(19) United States
(12) Patent Application Publication
(10) Pub. No.: US 2026/0025286 A1
(43) Pub. Date: Jan. 22, 2026

(54) MACHINE LEARNING USING PRIVATE AND PUBLIC BLOCKCHAIN DATA

(71) Applicant: PAYPAL, INC., San Jose, CA (US)

(72) Inventors: Rony Peled, Modïïn-Maccabim-Re"ut (IL); Yogev Matalon, Givatayim (IL)

(21) Appl. No.: 18/776,140

(22) Filed: Jul. 17, 2024

(51) Int. Cl. H04L 9/00; G06Q 20/36

(52) U.S. Cl. CPC H04L 9/50; G06Q 20/36; G06Q 2220/00; H04L 2209/56

(57) ABSTRACT

A computer-implemented method includes collecting information respective of one or more transactions stored on a public blockchain, determining that a first private account hosted by the computing system is associated with a first transaction of the one or more transactions, determining that a second private account hosted by the computing system is associated with a second transaction of the one or more transactions, associating the first private account with the second private account based on a connection of the first transaction to the second transaction on the public blockchain, and training a machine learning model according to the association of the first private account with the second private account.

### TECHNICAL FIELD

This disclosure relates to training machine learning models according to public and private blockchain network data, and the use of such models.

### BACKGROUND

In its broadest sense, blockchain refers to a framework that supports a trusted ledger that is stored, maintained, and updated in a distributed manner in a peer-to-peer network. For example, using a digital currency exchange, a user may buy any value of digital currency or exchange any holdings in digital currencies into worldwide currency or other digital currencies. Each transaction can be verified by the distributed ledger and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. For example, a supply chain may be maintained in a blockchain ledger, where the transfer of each component from party to party, and location to location, may be recorded in the ledger for later retrieval. Doing so allows for easier identification of a source for a defective part and where other such defective parts have been delivered. Similarly, food items may be tracked in like manner from farm to grocery store to purchaser.

### BRIEF DESCRIPTION OF THE DRAWINGS

FIG. 1 is a block diagram view of an example system for training a machine learning model using private and public blockchain data and deploying the model.

FIG. 2A is a block diagram view of an example relationship between public blockchain data and private blockchain data.

FIG. 2B is a block diagram view of an example relationship between public blockchain data and private blockchain data.

FIG. 3 is a set of tables illustrating an example relationship between public blockchain data and private domain data.

FIG. 4 is a diagrammatic view of an example graph supplemented using public and private blockchain data.

FIG. 5 is a flow chart illustrating an example method of training a machine learning model using private and public blockchain data and deploying the model.

FIG. 6 is a flow chart illustrating an example method of applying a machine learning model trained using private and public blockchain data.

FIG. 7 illustrates an example computing architecture for facilitating one or more blockchain based transactions.

FIG. 8 illustrates an example blockchain network.

FIG. 9 illustrates an example blockchain.

FIG. 10 is a diagram of an example transaction message.

FIG. 11 shows an example transaction broadcast the blockchain network.

FIG. 12A is a flow diagram showing steps of an example method for performing a blockchain based transaction.

FIG. 12B is a flow diagram showing steps of an example method for performing a blockchain based transaction.

FIG. 13A shows an example of a privately broadcasted blockchain.

FIG. 13B shows an example of blockchain misuse.

FIG. 14 illustrates an example of a blockchain enabled in-store purchase system.

FIG. 15 illustrates an example of communications for an IoT blockchain enabled device system.

FIG. 16 illustrates an example system.

FIG. 17 illustrates an example computing device.

### DETAILED DESCRIPTION

Because transactors are anonymous on most public blockchain ledgers, public blockchain activity generally does not provide significant insight for individual and community evaluation. For example, theoretically, public blockchain data can provide substantial information about fraud risk, individual and community tendencies, and the like, if activity could be associated with specific entities (e.g., transactors).

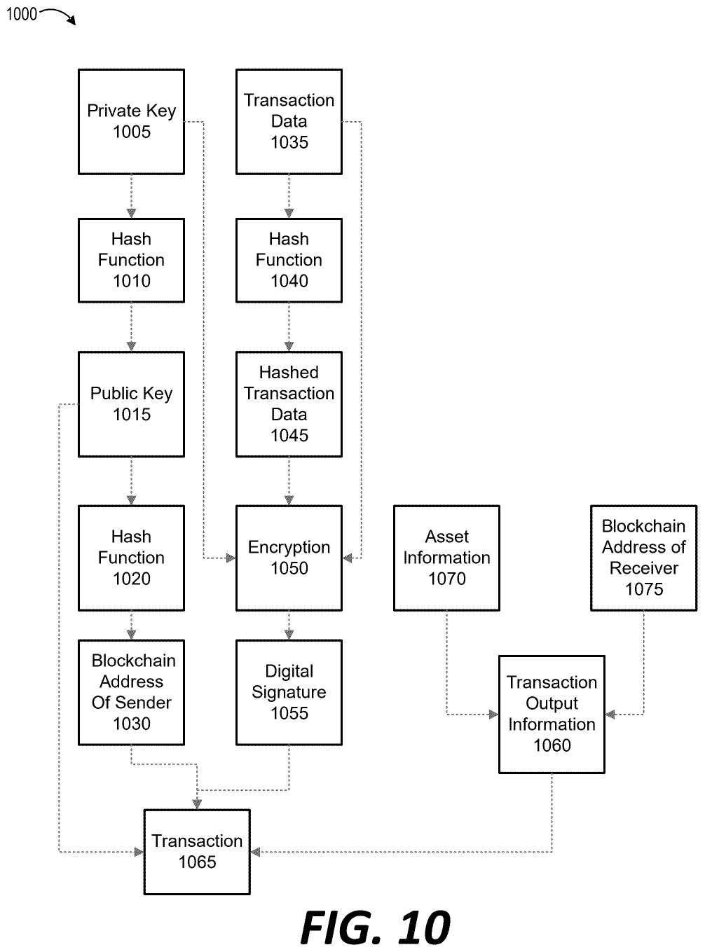

Some interactions with public blockchain ledgers are made through private services, such as digital wallet services, for example. The digital wallet service may be able to associate a public blockchain transaction with a particular user, because the digital wallet service may store an association between the user's digital wallet and the identifier used on the blockchain ledger for the user (e.g., a user address, as discussed in connection with FIG. 10). Accordingly, a digital wallet service (or other system with special knowledge of associations between blockchain transactions and users) may be able to associate activity across numerous blockchain ledgers with respective users, and may be able to improve upon known techniques based on blockchain data. For example, such systems may train machine learning models with such data to cause such models to function more effectively due to previously-unusable public data being usable for training and evaluation. In another example, such systems may be able to use information gleaned from public blockchain ledgers to build graphs associating users with other users, devices with each other, users with devices, and so on.

In some embodiments, the instant disclosure may find use in training and deploying domain-specific machine learning models. For example, existing models for classifying users, devices, addresses, and the like may be enhanced-made more accurate or more robust-via incorporation of user-to-user associations derived from public blockchain information, and by supplementing known transaction and activity information of users with the activity of those users on public blockchain ledgers.

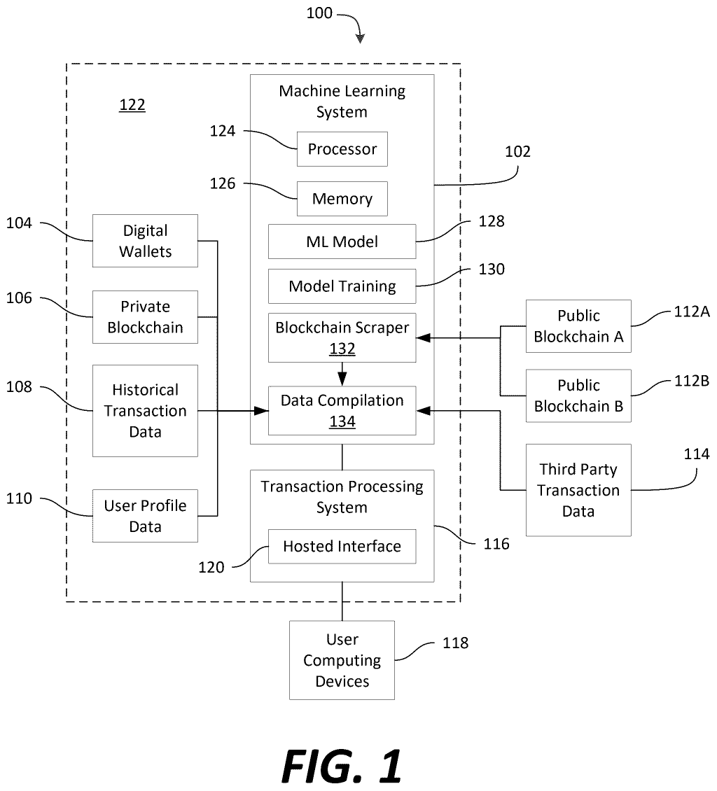

Turning to the figures, in which like numerals refer to the same or similar features in the various views, FIG. 1 is a block diagram view of an example system 100 for training a machine learning model using private and public blockchain data and deploying the model. The system 100 may include a machine learning system 102, a plurality of digital wallets 104, a private blockchain ledger 106, a source of historical transaction data 108, a source of user profile data 110, one or more public blockchain ledgers 112A, 112B, a source of third party transaction data 114, and a transaction processing system 116 that may communicate with one or more (e.g., a plurality of) user computing devices 118. Each of the components 102, 104, 106, 108, 110, 112A, 112B, 114, 116 of the system 100 may be embodied in one or more computing systems, and thus may be distributed across multiple computing systems and devices. Further, data stored or accessed by the machine learning system 102, digital wallets 104, source of historical transaction data 108, source of user profile data 110, source of third party transaction data 114, and transaction processing system 116 may be local to one or both of the machine learning system 102 or transaction processing system 116 and/or may be stored in cloud storage.

The transaction processing system 116 may be associated with (e.g., may host) a particular electronic user interface 120 and/or platform through which users (which may include individual users and/or enterprise users such as merchants, etc.) perform electronic transactions (e.g., any of merchant-to-user transactions, user-to-user transactions, and merchant-to-merchant or other business-to-business transactions). The electronic user interface 120 may be embodied in a website, mobile application, etc. Accordingly, the transaction processing system 116 may be associated with or wholly or partially embodied in one or more servers, which server(s) may host the interface 120, and through which the user computing devices 118 may access the user interface.

The historical transaction data 108 may include records of a plurality of previous transactions (or other computing actions) performed through the transaction processing system 116. The records may include, for each transaction, one or more users involved in the transaction and one or more characteristics of the transaction. The characteristics of the transaction may include, for example, dates, values, IP addresses and/or device IDs of the transactors, a subject of the transaction (e.g., asset access or exchanged), and so on. Accordingly, a given user may have one or more associated transactions stored in the historical transaction data 108.

The third party transaction data 114 may, like the historical transaction data 108, include records of a plurality of transactions, including one or more users involved in the transaction and one or more characteristics of the transaction. The third-party transaction data 114 may include, however, transactions performed other than through the transaction processing system 108 (e.g., transactions that were not processed by the transaction processing system 108). The third-party transaction data 114 may include, for example, credit bureau data or data from another third party source that tracks transactions or other computing actions by various users and entities.

The user profile data 110 may include user profiles for a plurality of users of the transaction processing system 116. A user profile may include, for example, a user's bibliographic information, location information, transaction history, associated IP addresses, device IDs, physical addresses, assets, and the like.

The digital wallets 104 may include a plurality of digital wallets, respective of users of the user computing devices 118, hosted by a digital wallet service. That is, the digital wallets may include a plurality of “hot” wallets. In some embodiments, the digital wallets may additionally include one or mode “cold” wallets that have interacted with the transaction processing system 116, or that have interacted with the private blockchain 106. The digital wallets 104 may store assets exchangeable through the private blockchain, and/or one or more public blockchains, or may have previously stored one or more of such assets. Each digital wallet 104 may be associated with a respective private user account (e.g., an account with the digital wallet service and/or an account with the transaction processing system 116), a specific user, one or more device IDs, one or more IP addresses, and/or one or more blockchain addresses associated with specific blockchain networks, etc.

The private blockchain ledger 106 may include a record of transactions made on a private blockchain network, such as a blockchain network used only through the transaction processing system 116 or otherwise controlled by the transaction processing system 116. For example, the private blockchain network may include records of transactions for a single type of asset only used within the transaction processing system 116 (e.g., between users of the transaction processing system 116). Such a single asset may be used, for example, by the transaction processing system 116 as an intermediary between other asset classes or asset types. In some embodiments, the private blockchain (recorded on the private blockchain ledger 106) may be accessible by users only through the digital wallets 104. Accordingly, users may use the digital wallets 104 to exchange an asset on a public blockchain (e.g., represented on a public blockchain ledger 112) for an asset on the private blockchain, and vice-versa.

The public blockchain ledgers 112A, 112B may be ledgers respective of the same blockchain network (e.g., duplicate ledgers maintained by different nodes on the same blockchain network), and/or ledgers respective of different blockchain networks. Two such ledgers are shown in FIG. 1, public blockchain A ledger 112A, and public blockchain B ledger 112B, but any number of ledgers for any number of blockchain networks may find use with the system 100.

The digital wallets 104, the private blockchain ledger 106, and the machine learning system 102 may be operated by the same private host entity 122, in some embodiments. Accordingly, the machine learning system 102 may have unique knowledge of the digital wallets 104 and the private blockchain ledger 106 that is not available to the public. Further, in some embodiments, the historical transaction data 108 and/or the user profile data 110 may also be proprietary to the host 122 that operates the digital wallets 104, the private blockchain ledger 106, and the machine learning system 102. Still further, the same host 122 may operate the machine learning system 102 and the transaction processing system 116, in some embodiments. One or more of the digital wallets 104 and the transaction processing system 116 may be associated with private user accounts, i.e., accounts respective of users hosted by the host entity 122, where those accounts are specific to the digital wallets 104 and/or transaction processing system 116, and where the details of each private user account are not publicly available.

In some embodiments, the transaction processing system 116 may perform or facilitate blockchain transactions for users/holders of the digital wallets 104. For example, a user of a digital wallet 104 may instruct a transferal of a certain asset volume, and the transaction processing system 116 may select a specific asset—either an asset recorded on a public blockchain ledger 112 or an asset recorded on the private blockchain ledger 106—and perform the instructed transfer. The selection may be according to, for example, the recipient of the asset volume. Where the recipient is a user with a digital wallet 104, the transaction processing system 116 may select the private blockchain asset and transfer the desired asset volume with the private blockchain asset. Where the recipient is a user without a digital wallet 104, the transaction processing system 116 may select the public blockchain asset and transfer the desired asset volume with the public blockchain asset. In another example, where the recipient is in a location in which public blockchain assets are legally restricted, the transaction processing system 116 may select the private blockchain asset and transfer the desired asset volume with the private blockchain asset.

Assets recorded on the public and private blockchains discussed herein may include, for example, cryptocurrencies, other decentralized finance (DeFi) assets, non-fungible tokens (NFTs), and/or smart contracts.

The machine learning system 102 may include a processor 124 and a non-transitory, computer-readable memory 126 that, when executed by the processor 124, cause the machine learning system 102 to perform one or more processes, operations, methods, algorithms, etc. of this disclosure. The machine learning system 102 may include one or more functional modules 128, 130, 132, 134. Specifically, the machine learning system 102 may include a machine learning model module 128 (which may be referred to herein simply as the model 128), a model training module 130, a blockchain scrape module 132, and a data compilation module 134. Each module 128, 130, 132, 134 may be embodied in hardware and/or software (e.g., as instructions in the memory 126).

The model 128 may be or may include a neural network (e.g., graph neural network) or other model type that may be used for making predictions (e.g., labels or classifications) based on various input parameters/data, which predictions may be further used for decision making. For example, the model 128 may determine whether one or more entities are trusted or untrusted, which may guide subsequent decisions regarding trusted or untrusted entities. In another example, the model 128 may classify or quantify a risk associated with an input user and an input transaction or other user-requested computing action.

The machine learning model training module 130 may be configured to receive an untrained or partially trained machine learning model and to train the model for one or more specific purposes. In some contexts, the training module 130 may train a neural network for use in financial-related, risk-related and/or other decisions related to granting users permission to engage in computing actions, including but not limited to credit applications, fraud detection, site access, shared resource access, further blockchain network participation, etc. In some embodiments, the training module 130 may train the model to classify an asset as trusted or untrusted, to predict a next user action, and/or other purposes. The training module 130 may apply one or more of reinforcement learning, supervised learning, unsupervised learning, RAG learning, and/or another appropriate training technique.

In some embodiments, the training module 120 may train a machine learning model, such as a linear regression based binary classification model, neural network, or other model, to predict a classification/label, namely a probability of a failed computing action (e.g., default) at a given future time frame (e.g., at 18 months or any future time frame) or other risk score (as used herein, a “risk score” may also be referred to as a “decision score,” according to various embodiments). Such a risk score may be used to classify an asset as trusted or untrusted. This model may use various input parameters or variables. For instance, for a target user, the input features may include target user data of the target user that is available from one or more sources (e.g., the historical transaction data, the third party transaction data, the user profile data, etc.). This target user data may correspond to short term user data indicative of short term risk factors, such as time (e.g., months, weeks, days, years, etc.) from opening a most recent account, a number of new accounts in a time frame (e.g., last 12 months or any other appropriate period of time), a number of revolving accounts with a certain (e.g., 75% or any other appropriate percent) utilization rate, and/or other balances. The target user data may also correspond to long term user data indicative of long term risk factors, such as a number of months of delinquency (e.g., 3 or more months or any other number of months), a number of months since a last default, a ratio of transaction declines in a time frame (e.g., last 12 months or any other appropriate period of time), a number of months since a 1 month delinquency (e.g., for live accounts), etc. Where used for risk classification in other contexts (e.g., shared computing access, site access), the target user data may include the user's history of access to other sites or other shared resources, first-order (also referred to herein as “one-hop”), second-order (“two-hop”), and/or greater-order connections of the users to known suspicious entities (or the reputations of connected entities to the user), a quantity of sites or shared computing resources to which the user already has access, and the like.

The model 128 may be trained to predict, from the input features, a probability of default or other adverse outcome at the future time frame for the target user, which may further be used to place the target user in a risk quantile (e.g., decile, percentile, etc.). Risk quantiles considered low risk may be considered for credit approval or approval for another transaction or computing action. Moreover, within the approved quantiles, a credit line determination (e.g., between a high credit line and a low credit line) may be based on the risk quantile, with lower risk quantiles being recommended for higher credit lines. In some examples, users (e.g., borrowers seeking credit) may be categorized into the risk quantiles or risk score bands based on users' credit risk profiles. The risk quantiles may be used for allocation of credit limits and/or interest rates. For instance, users with lower assessed risk (e.g., categorized into a low risk quantile) may receive higher credit limits and lower interest rates, whereas higher-risk users (e.g., categorized into a higher risk quantile) may receive lower credit limits and/or higher interest rates. Alternatively, for other types of computing actions, other quantitative restrictions or requirements may be imposed, such as computing or monetary collateral, time-based access or usage restrictions, and the like. In addition, regular reviews and adjustments of credit lines may be conducted to align with changes in borrower risk profiles. Accordingly, using risk quantiles may allow responsible lending, regulatory compliance, and risk management, which may further foster transparency and fairness in a lending process.

The blockchain scraper module 132 may scrape, retrieve, or otherwise collect or receive data respective of a plurality of transactions recorded on the public blockchain ledgers 112. Such data may include, for each of a plurality of transactions, an address on the blockchain where the transaction is recorded, a respective address (e.g., blockchain address) associated with each transactor, and/or identifiers of one or more assets exchanged in the transaction. The collected information from the public blockchain ledgers 112 may be in the form of hashes of the information, for example.

The data compilation module 134 may receive data from one or more sources and may establish or otherwise determine associations within the data. For example, the data compilation module 134 may receive public blockchain data from the blockchain scraper module 132, may receive information respective of the digital wallets 104, and may associate transactions on a public blockchain 112 with particular digital wallets 104 and/or users of such wallets (e.g., may fuse public and private blockchain data). For example, the data compilation module 134 may find connections between private user accounts of the transaction processing system 116 and/or the digital wallets 104, where those connections exist in the public blockchain data, but not in the proprietary information of the host entity 122. The data compilation module 134 may further supplement information respective of a single user or device with information from the private blockchain ledger 106 (e.g., transactions in which a given user engaged on the private blockchain), user profile data 110, historical transaction data 108, and/or third party transaction data 114. In compiling data and determining connections, the data compilation module 134 maya generate one or more tables representative of one or more public blockchains, or portions thereof, in which individual transactions are represented as respective rows or other distinct structures in a table. Such tables may provide easier searching of public blockchain transactions to find connections between device addresses or transactor addresses.

The data compiled and associations established by the data compilation module 134 may be applied by the model training module 130 to improve the functionality (e.g., accuracy, scope) of the model 128. Additionally or alternatively, the data compiled and associations established by the data compilation module 134 may be used as input to the model 128 for the model 128 to make predictions, classifications, etc. respective of the entities and actions represented in that data, and/or respective of one or more new entities or actions.

In some embodiments, the machine learning system 102 may be deployed in order to predict a next user action, such as a next user action in the hosted interface 120. In such an embodiment, the machine learning model 128 may receive, as input, a series of actions of the user and may output one or more predicted next actions, along with confidence values for each predicted next action. Based on such predictions, the transaction processing system 116 may offer the predicted next action in the hosted interface 120, for example.

The machine learning system 102 may be deployed, in some embodiments, in order to classify one or more entities as trusted or untrusted. Such a classification may affect or determine later processing of computing actions involving those entities. For example, where the entity is an IP address and is classified as trusted, transactions or other computing actions originating from that IP address may be processed or approved through a simpler process than if the IP address were not classified as trusted.

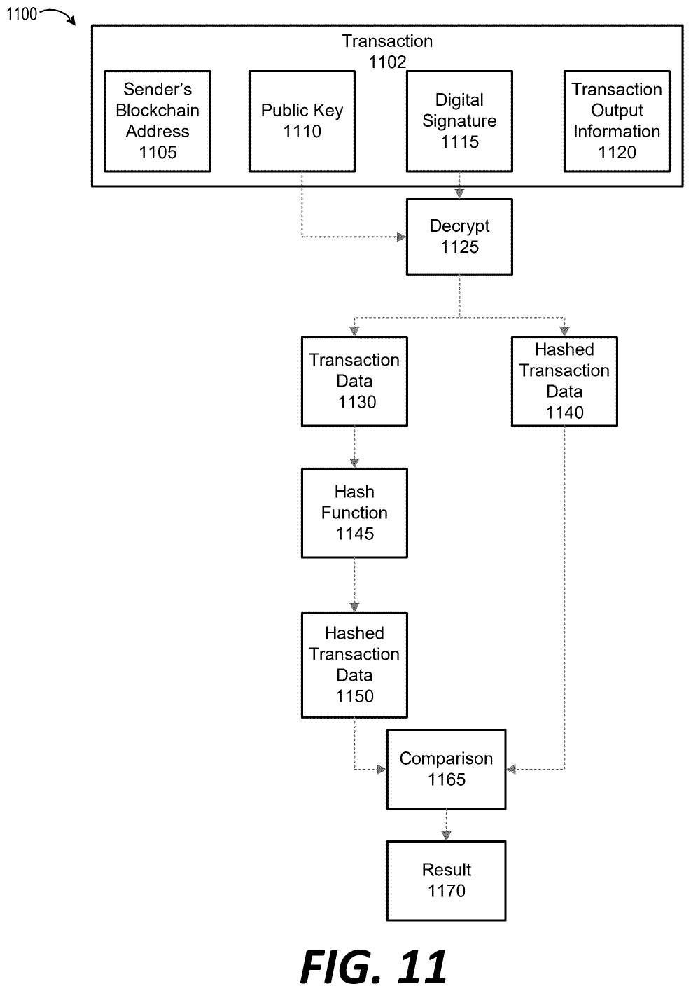

As noted above, the machine learning model 102 may classify risk with respect to a user-requested computing action. For example, the machine learning system (e.g., the functionality thereof) may be deployed in order to determine whether or not a user or other entity is permitted to engage in further blockchain transactions. Examples of such transactions are described in connection with FIGS. 11-15. For example, a risk associated with a user may prevent (or enable) such transactions on a private blockchain 106, or such a risk may be propagated to nodes on a public blockchain 112 for the nodes of the blockchain 112 to employ appropriate risk mitigation when adding transactions of the user to the blockchain.

In another example, the machine learning system 102 (e.g., the functionality thereof) may be deployed in order to determine whether or not to extend credit to users. In such embodiments, a user's requested computing action may be the request for credit (e.g., a request to perform a certain transaction on credit). In such embodiments, the machine learning model 128 may receive information about the user (including, for example, associations between the user and other entities) and the requested amount of credit and output a risk associated with extending the credit to the user. The risk may represent, for example, a risk that the user will default on the credit.

In other embodiments, the machine learning system 102 may be deployed in order to determine whether or not to grant access to a common computing service to users. In such embodiments, a user's requested computing action may be a request to use a certain volume of computing resources, or a request to perform a certain series of computations using the common computing service. In such an embodiment, the machine learning model 128 may receive information about the user (including, for example, associations between the user and other entities) and the requested quantity or type of computing resources and output a risk associated with permitting the user access to the requested computing resources. The risk may represent, for example, a risk that the user may perform unauthorized operations with the shared computing resources (e.g., illegal activity, for example), a risk that the user may upload malicious code to the shared computing resources, or some other risk.

In other embodiments, the machine learning system 102 may be deployed in order to determine whether or not to grant access to a physical site (e.g., a facility, specific computing hardware, etc.) to users. In such embodiments, a user's requested computing action may be a request to access the site (e.g., presentation of a credential by the user at a secure access scanner), or to be authorized to access the site. In such an embodiment, the machine learning model 128 may receive information about the user (including, for example, associations between the user and other entities) and the site (e.g., the value of hardware at the site, or downside value of potential illicit activity at the site) and output a risk associated with permitting the user access to the requested site. The risk may represent, for example, a risk of theft associated with the user, a risk that the user will damage the site or some portion of the site, or some other risk.

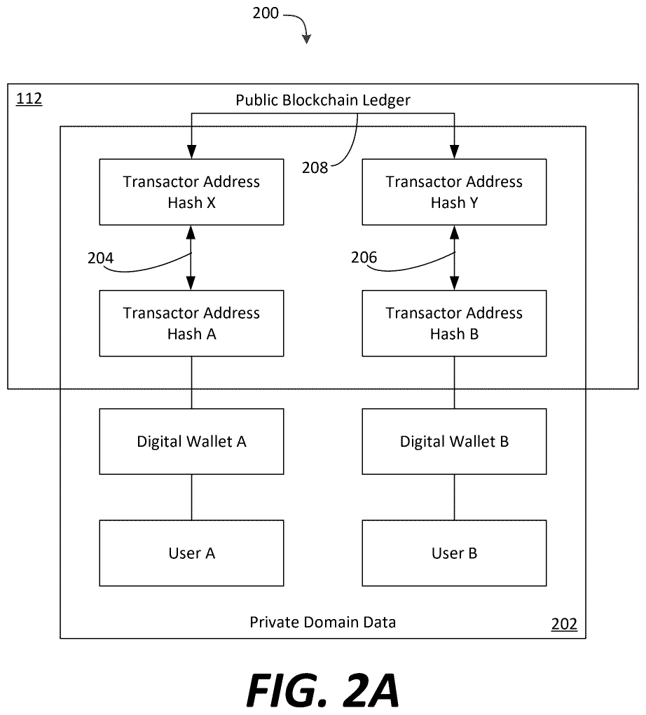

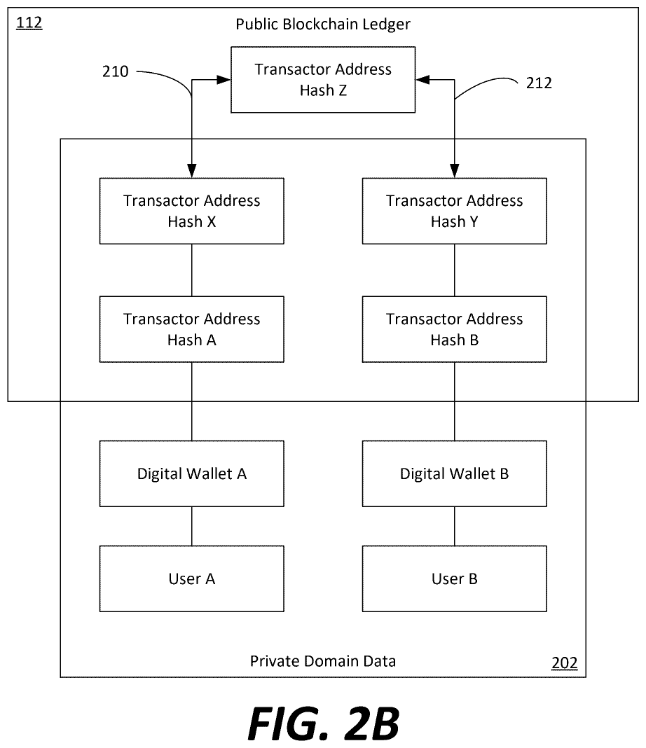

As noted above, public blockchain data may be used to establish connections between private user accounts. Stated another way, private account data may be used to determine public blockchain connections between users, devices, and assets. FIG. 2A is a block diagram 200 illustrating one type of such a connection. FIG. 2A illustrates a scope of information on a public blockchain 112 and a partially-overlapping scope of private domain data 202. The private domain may correspond, for example, to the host 122 of FIG. 1.

In FIG. 2A, a first user (User A) has entered into a transaction 204 with a second user (User B), and that transaction 204 is recorded on the public blockchain ledger 112. For the transaction 204, the public blockchain ledger 112 includes a transactor hash address X and a device address hash A for a first transactor, as well as a transactor hash address Y and a device address hash B for a second transactor, but does not include any information identifying either transactor.

The private domain data 202, however, includes the hash information respective of both transactors, as well as additional information respective of both transactors. For example, the private domain data 202 includes an association between device address hash A and digital wallet A, which is the digital wallet associated with device address A. Furthermore, the private domain data 202 includes an association between digital wallet A and user A, and therefore other information respective of user A. Similarly, the private domain data 202 includes an association between device address hash B and digital wallet B, which is the digital wallet associated with device address B, as well as an association between digital wallet B and user B, and therefore other information respective of user B. In some embodiments, the digital wallets A, B may store or be associated in the private domain data directly with the respective transactor address hashes X, Y, respectively. As a result of the public blockchain transaction 204 in FIG. 2A, user A may be associated with user B. The association illustrated in FIG. 2A, in which user A has directly transacted with user B, may be referred to as a “one-hop” association between user A and user B.

The private domain data 202 may include, for both User A and User B (e.g., for both device address A and device address B), respective lists of public blockchain transactions. For each such transaction, the digital wallet A, B may store a hash of the blockchain location where the transaction is recorded, as well as the user device address and transactor address and account number, and a device address and transactor address for the other party to the transaction. Via links between transactor addresses and/or device addresses in transactions represented in multiple wallets, the private domain data may include connections in the public blockchain data that are not apparent from the public blockchain data alone (e.g., the connections between user accounts and users themselves may not be apparent) or from the private domain data alone.

While FIG. 2A illustrates a one-hop connection between user A and user B, FIG. 2B illustrates a two-hop connection between user A and user B. Like the example of FIG. 2A, in the example of FIG. 2B, each of user A and user B is associated with a respective digital wallet A, B, a respective device address hash A, B on the public blockchain 112, and a respective transactor address hash X, Y on the public blockchain 112. In the example of FIG. 2B, the transactor address associated with user A (address hash X) has engaged in a first transaction 302, recorded on the public blockchain ledger 112, in which transactor address hash Z is the other transactor. In addition, the transactor address associated with user B (address hash Y) has engaged in a second transaction 304, recorded on the public blockchain ledger 112, in which transactor address hash Z is the other transactor. Based on user A and user B having transacted with a common third party (transactor address hash Z), a two-hop connection may be established between user A and user B, whether or not any further information is known about transactor address hash Z.

As noted above, for each blockchain transaction involving user A or user B in the private domain data 202, the digital wallet A, B may store a hash of the blockchain location where the transaction is recorded, as well as the user device address and transactor address and account number, and a device address and transactor address for the other party to the transaction. Common connections may be found within those wallets to third party device addresses or transactor addresses to establish two-hop connections, which connections are again not apparent from public blockchain data alone or from the private domain data alone.

Deriving connections between users through public blockchain data, such as in the examples of FIGS. 2A and 2B, and utilizing such connections in the training and application of machine learning models may increase the accuracy and robustness of such models, both when applied to the users involved in those connections and to other users.

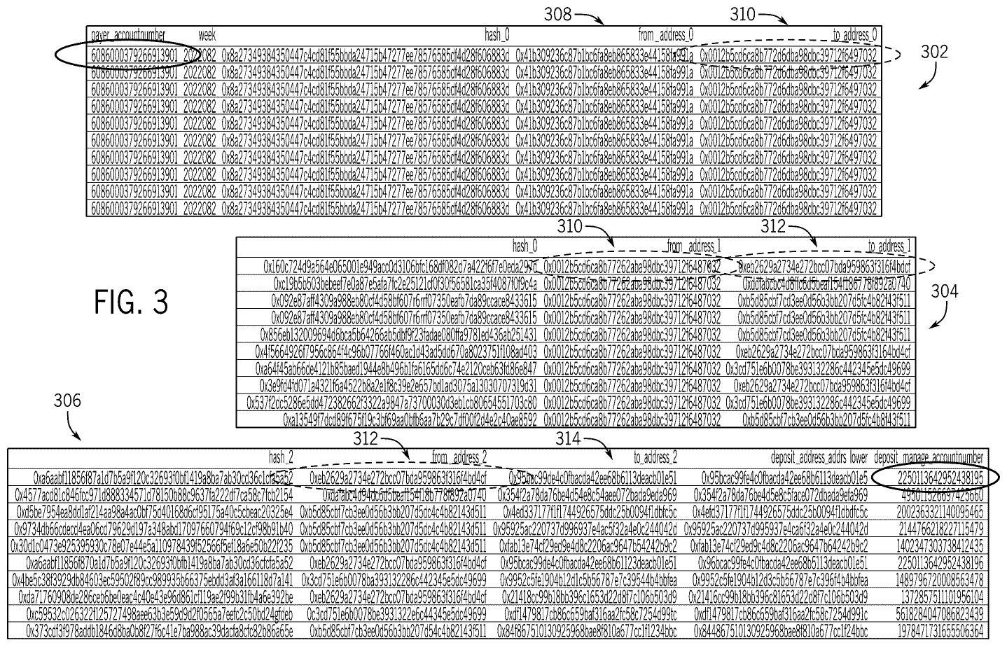

FIG. 3 is a set of tables illustrating an example relationship between public blockchain data and private domain data. In FIG. 3, a two-hop connection is shown. Three tables 302, 304, 306 illustrate a first user's (e.g., User A in FIGS. 2A and 2B) transactions 302 stored in the first user's digital wallet, a set of public blockchain transactions 304, and a second user's (e.g., User B in FIGS. 2A and 2B) transactions 306 stored in the second user's digital wallet. The first and third tables 302, 306 were derived from private domain data, and the second table 304 was derived from public blockchain data. In the first and third tables 302, 306, the account number information is not public information, and thus the relationships between the account numbers and transactor addresses is uniquely known to the holder of the private domain data.

The first table 302, and thus the first user's wallet, includes a transaction involving the first user, with a first transactor address (“0x41 . . . 991a”) 308, and a first third party transactor address (0x00 . . . 7032″) 310. The public blockchain transactions 304 include a transaction involving the first third party transactor address (0x00 . . . 7032″) 310 and a second third party transactor address (“0xeb . . . d4cf”) 312. The third table 306, and thus the second user's digital wallet, includes a transaction involving the second user, with a second transactor address (“0x95 . . . 1e51”) 314, and the second third party transactor address (“0xeb . . . d4cf”) 312. Based on these transactions, direct (one-hop) connections may be established between the first user and the first third party, and between the second user and the second third party, and between the first third party and the second third party, respectively. Based on those direct connections, a two-hop connection may be established between the first user and the second user.

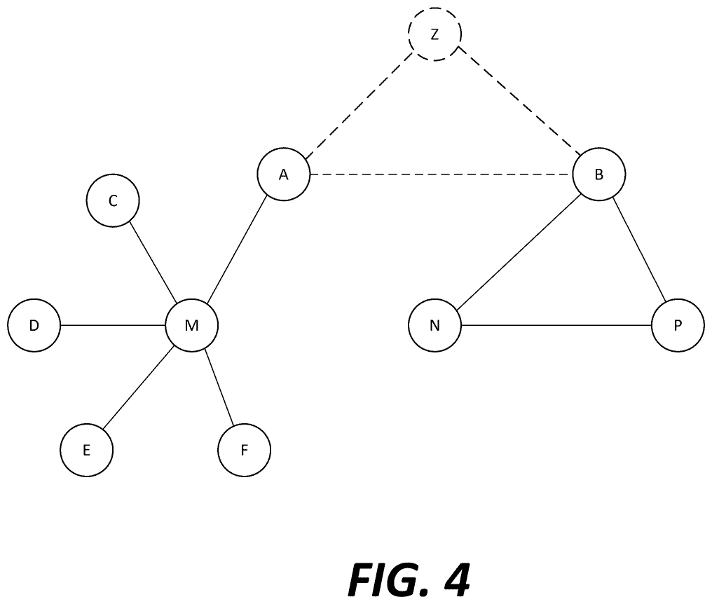

FIG. 4 is a diagrammatic view of an example graph supplemented using public and private blockchain data. As described above, one way in which fused public and private blockchain data may be used is to supplement a graph, such as a transaction graph, a relationship graph, etc. In the example of FIG. 4, the graph has been supplemented according to the public and private blockchain data shown in FIGS. 2A and 2B. Before such public blockchain data, the graph included entities, A, B, C, D, E, F, M, N, and P, with inter-entity associations shown as solid lines. Added entities and connections are shown in dashed lines. Based on the fused public and private blockchain data, a new association may be made between entity A and entity B, entity Z may be added to the graph, and associations between entities A and B with entity Z may be added. Based on such new associations, indirect (e.g., multi-hop) associations of entity A to entities N and P are also established. Similarly, indirect associations of entity B to entities C, D, E, F, and M are established.

After the new associations are added to the graph, the graph may be used to train a GNN and/or as input to a GNN in order to make more accurate predictions respective of one or more of the entities in the graph, and/or a proposed computing action involving one or more of the entities in the graph. Furthermore, the entities and relationships represented in the graph may be associated with additional public and/or private domain data, including user profile information, historical transaction data, and the other data set forth above with respect to FIG. 1.

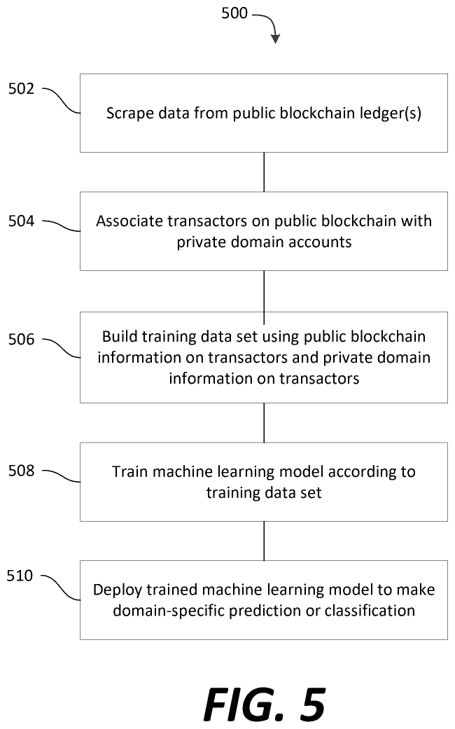

FIG. 5 is a flow chart illustrating an example method of training a machine learning model using private and public blockchain data and deploying the model. The method 500, or one or more aspects of the method 500, may be performed by the machine learning system of FIG. 1, in some embodiments, and thus the method 500 may be computer-implemented and/or server-implemented.

The method 500 may include, at operation 502, obtaining (e.g., scraping) data from one or more public blockchain ledgers (e.g., a plurality of public blockchain ledgers). Operation 502 may include scraping or otherwise collecting or receiving data respective of one or more ledgers of one or more blockchain networks (e.g., a plurality of blockchains). Block 502 may include, in an embodiment, crawling a copy of a ledger obtained from a mining node on a blockchain and, based on the crawling, extracting each transaction from the blockchain, including details regarding the transactors and the assets exchanged in each transaction. For non-transactional records on the blockchain, operation 502 may include extracting the data recorded, as well as the one or more users associated with the recorded data. In some embodiments, operation 502 may include obtaining an existing record of such blockchain data, having already been extracted from a ledger.

The method 500 may further include, at operation 504, associating transactors on the public blockchain with private domain accounts. Transactors on the public blockchain may be associated with private domain accounts by, for example, determining that a device address hash on the public blockchain represents a digital wallet, and a user associated with that digital wallet, in domain-specific data that is private to a host entity (e.g., where the host entity is performing operation 504). In such an example, operation 504 may include determining, for each of a plurality of transactions and/or transactors, that a transactor address hash found on the public blockchain for a transaction matches a transactor address hash in the digital wallet associated with a particular public account.

Operation 504 may further include associating transactors with one another. Transactors may be associated with one another as a result of one-hop connections through a public blockchain (e.g., as illustrated in FIG. 2), two-hop connections (as illustrated in FIG. 3), or another type of connection.

In an example, operation 504 may include determining that a first private account is associated with a first transaction (e.g., by virtue of a digital wallet of the first private account being involved in the first transaction) scraped from the public blockchain ledger and that a second private account is associated with a second transaction scraped from the public blockchain ledger (e.g., by virtue of a digital wallet of the second private account being involved in the second transaction). Operation 504 may further include determining that the first and second transactions are connected to each other on the public blockchain, and thus the first private account is associated with the second private account. For example, the first and second transactions may be the same transaction, and thus the association is a one-hop connection. In another example, the first and second transactions may be different transactions, but may have a common counterparty (e.g., third user), and thus the association is a two-hop connection.

In some embodiments, operation 504 may include establishing one-to-one associations between private user accounts based on the public blockchain data. Such one-to-one associations may include, for example, one-to-one associations between private user accounts that have directly (one-hop) or indirectly (two-hop or greater) engaged with each other in public blockchain transactions.

The method 500 may further include, at operation 506, building a training data set using public blockchain information on a plurality of transactors and private domain information on a plurality of transactors. The training data set may include the associations established in operation 504, as well as data respective of a plurality of entities, including the user entities involved as transactors at operation 504. The training data set may include, for each user, one or more of public blockchain activity, private blockchain activity, user profile data, historical transaction data, third party transaction data, and/or other information.

In some embodiments, operation 506 may include building a graph, or supplementing a graph, according to the private user account associations established at operation 504 (e.g., as illustrated in and described with respect to FIG. 4). The graph may include a plurality of nodes, the nodes including the private user accounts, and a plurality of edges, the edges defined by the one-to-one associations.

The method 500 may further include, at operation 508, training a machine learning model according to the training data set. Training at operation 508 may include training to model to make one or more predictions or classifications. For example, as discussed above, training at operation 508 may include training the machine learning model to predict the risk of a failed computing action at one or more time periods, given an input user or other entity and an input computing action. Additionally or alternatively, operation 508 may include training a machine learning model to predict a next user action and/or to classify a user as trusted or untrusted.

The method 500 may further include, at operation 510, deploying the trained machine learning model to make a prediction or classification, such as a domain-specific prediction or classification. In some embodiments, the trained machine learning model may be deployed for real-time application by a transaction processing system. As discussed above, the trained machine learning model may be deployed in connection with determining whether or not to extend credit to users, whether or not to grant users access to a shared computing resource, whether or not to permit a user to perform a transaction on a public or private blockchain, whether or not to grant a user access to a physical site, to predict a next user action, etc. In some embodiments, operation 510 may include applying a graph neural network to a graph built or supplemented at operation 506 in order to make a prediction or classification respective of one or more nodes or edges in the graph. The prediction may be based on input respective of a particular domain (e.g., input received from the host entity), and the prediction may also be respective of the same domain (e.g., for an action to be processed by the transaction processing system), and thus may be domain-specific.

In some embodiments, the method 500 may be repeated periodically respective of the same model to update the relevant data set and re-train and/or tune the model with additional data. Further, in some embodiments, after a broader set of combined public and private blockchain data is used to train a model, a subset of the data set may be used to further train and tune the model. Still further, in some embodiments, one set of combined public and private blockchain data (e.g., data combined through a first public blockchain) may be used to train the model in a first round, and then combined public and private blockchain data (e.g., data combined through a second public blockchain) may be used in a second round of training, and so on.

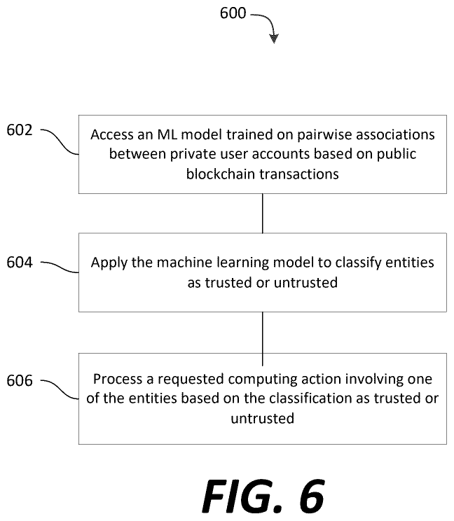

FIG. 6 is a flow chart illustrating an example method 600 of applying a machine learning model trained according to public and private blockchain data. The method 600, or one or more aspects of the method 600, may be performed by the machine learning system of FIG. 1, in some embodiments, and thus the method 500 may be computer-implemented and/or server-implemented.

The method 600 may include, at operation 602, accessing a machine learning model trained on one-to-one associations between private user accounts, where the one-to-one associations were established according to information respective of a plurality of transactions stored on a public blockchain and the plurality of transactions involved the user accounts. For example, the one-to-one associations may have been determined according to a plurality of the transactions in which the private user accounts transacted with each other (e.g., one-hop associations). In another example, the one-to-one associations between the private user accounts may have been determined according to a plurality of the transactions in which the private user accounts transacted with a common third party (e.g., two-hop associations).

Accessing the machine learning model at operation 602 may include, in some embodiments, training the machine learning model, as described with respect to method 500 and throughout this disclosure. In other embodiments, accessing the machine learning model at operation 602 may include accessing an already-trained model. Further, accessing the machine learning model at operation 602 may include utilizing a locally-stored model or a network-stored model, or may include accessing the model on a service basis.

The method 600 may further include, at operation 604, applying the machine learning model to a plurality of entities to classify each of the plurality of entities as trusted or untrusted. Each of the plurality of entities may be or may include a user, an IP address, a physical address, or a device identifier. Such a classification may affect or determine later processing of computing actions involving the classified entity or entities. For example, where the entity is an IP address and is classified as trusted, transactions or other computing actions originating from that IP address may be processed or approved through a simpler process than if the IP address were not classified as trusted. The entities may be entities that were involved in one or more of the public blockchain transactions that were used to establish associations on which the machine learning model was trained, in some embodiments.

In some embodiments, operation 604 may include applying the trained machine learning model to predict a next user action, such as a next user action in a hosted interface. In such an embodiment, the trained model may receive, as input, a series of actions of the user and may output one or more predicted next actions, along with confidence values for each predicted next action. Based on such predictions, the predicted next action may be offered in the hosted interface, for example.

In some embodiments, operation 604 may include applying the trained machine learning model to classify risk with respect to a user-requested computing action. For example, the output of the trained model may indicate whether or not a user or other entity should be permitted to engage in further blockchain transactions. For example, a risk associated with a user may prevent (or enable) such transactions on a private blockchain, or such a risk may be propagated to nodes on a public blockchain for the nodes of the blockchain to employ appropriate risk mitigation when adding transactions of the user to the blockchain.

The method 600 may further include, at operation 606, processing a requested computing action involving one of the entities based on the classification of the one of the entities as trusted or untrusted. For example, operation 606 may include determining that an entity requesting a computing action is classified as untrusted and, in response, requiring a second authentication factor from the entity before approving the computing action. The requested computing action may be, for example, an inter-party transaction, access to a shared computing resource, or access to a secure physical site.

A description of blockchain principles that may find user with the concepts above follows.

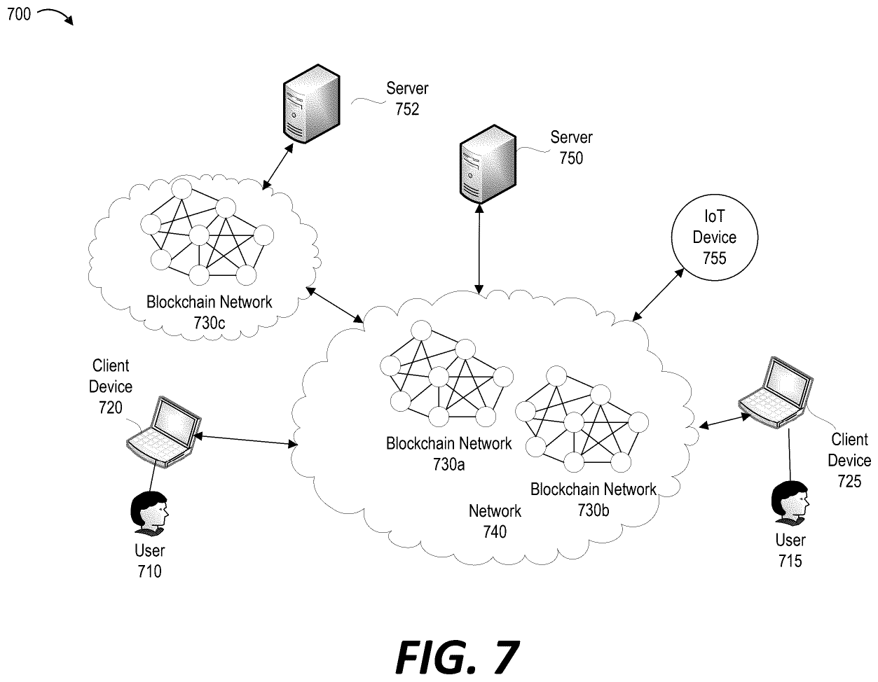

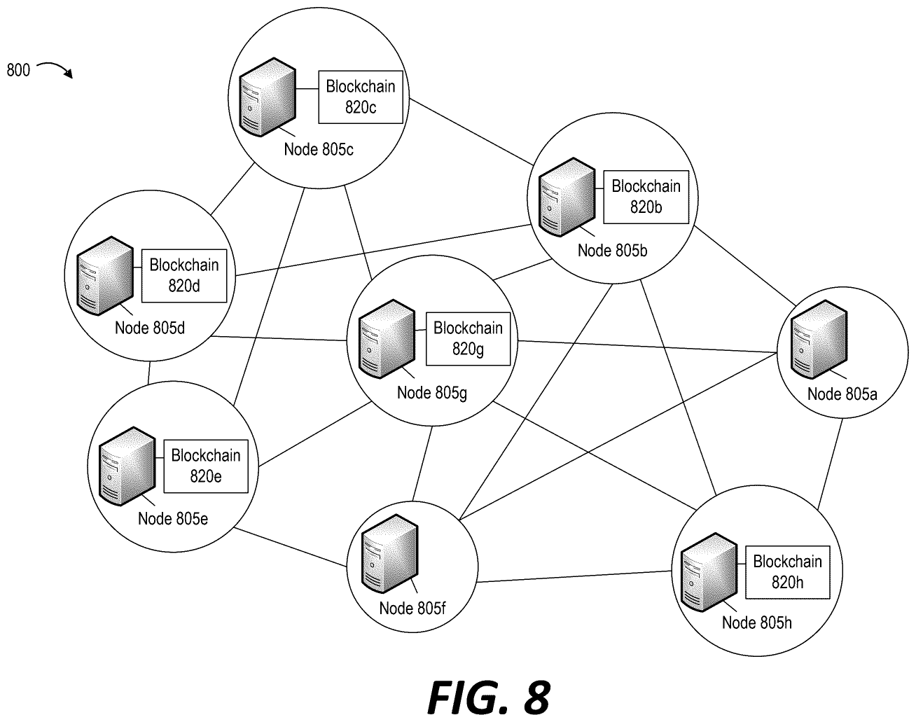

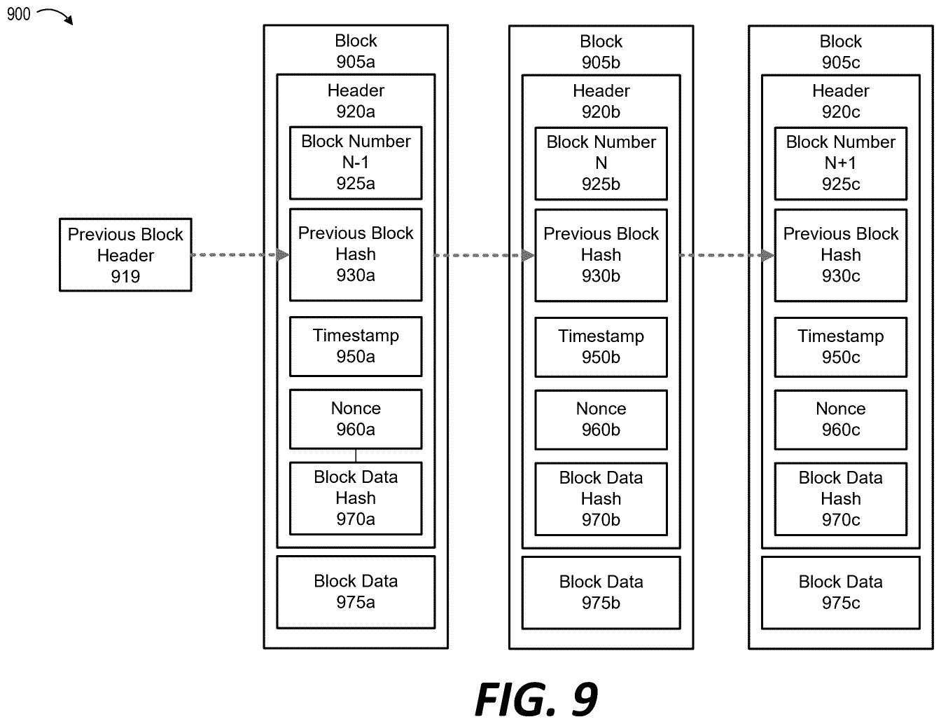

Computing Architecture. As discussed above, the distributed ledger in a blockchain framework is stored, maintained, and updated in a peer-to-peer network. In one example the distributed ledger maintains a number of blockchain transactions. FIG. 7 shows an example system 700 for facilitating a blockchain transaction. The system 700 includes a first client device 720, a second client device 725 (which client devices 720, 725 may be the same as or different from the user computing devices 118 of FIG. 1), a first server 750, and an Internet of Things (IoT) device 755 interconnected via a network 740. The first client device 720, the second client device 725, the first server 750 may be a computing device 905 described in more detail with reference to FIG. 9. The IoT device 755 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 740 may be any of a variety of available networks, such as the Internet, and represents a worldwide collection of networks and gateways to support communications between devices connected to the network 740. The system 700 may also comprise one or more distributed or peer-to-peer (P2P) networks, such as a first, second, and third blockchain network 730a-c (generally referred to as blockchain networks 730). As shown in FIG. 7, the network 740 may comprise the first and second blockchain networks 730a and 730b. The third blockchain network 730c may be associated with a private blockchain as described below with reference to FIG. 8, and is thus, shown separately from the first and second blockchain networks 730a and 703b. Each blockchain network 730 may comprise a plurality of interconnected devices (or nodes) as described in more detail with reference to FIG. 8. As discussed above, a ledger, or blockchain, is a distributed database for maintaining a growing list of records comprising any type of information. A blockchain, as described in more detail with reference to FIG. 9, may be stored at least at multiple nodes (or devices) of the one or more blockchain networks 730.

In one example, a blockchain based transaction may generally involve a transfer of data or value between entities, such as the first user 710 of the first client device 720 and the second user 715 of the second client device 725 in FIG. 7. The server 750 may include one or more applications, for example, a transaction application configured to facilitate the transaction between the entities by utilizing a blockchain associated with one of the blockchain networks 730. As an example, the first user 710 may request or initiate a transaction with the second user 715 via a user application executing on the first client device 720. The transaction may be related to a transfer of value or data from the first user 710 to the second user 715. The first client device 720 may send a request of the transaction to the server 750. The server 750 may send the requested transaction to one of the blockchain networks 730 to be validated and approved as discussed below.

Blockchain Network. FIG. 8 shows an example blockchain network 800 comprising a plurality of interconnected nodes or devices 805a-h (generally referred to as nodes 805). Each of the nodes 805 may comprise a computing device 905 described in more detail with reference to FIG. 9. Although FIG. 8 shows a single device 805, each of the nodes 805 may comprise a plurality of devices (e.g., a pool). The blockchain network 800 may be associated with a blockchain 820. Some or all of the nodes 805 may replicate and save an identical copy of the blockchain 820. For example, FIG. 8 shows that the nodes 805b-e and 805g-h store copies of the blockchain 820. The nodes 805b-e and 805g-h may independently update their respective copies of the blockchain 820 as discussed below.

Blockchain Node Types. Blockchain nodes, for example, the nodes 805, may be full nodes or lightweight nodes. Full nodes, such as the nodes 805b-e and 805g-h, may act as a server in the blockchain network 800 by storing a copy of the entire blockchain 820 and ensuring that transactions posted to the blockchain 820 are valid. As a result, the blockchain scraper module of FIG. 1 may scrape a ledger from any full node on a public blockchain. The full nodes 805b-e and 805g-h may publish new blocks on the blockchain 820. Lightweight nodes, such as the nodes 805a and 805f, may have fewer computing resources than full nodes. For example, IoT devices often act as lightweight nodes. The lightweight nodes may communicate with other nodes 805, provide the full nodes 805b-e and 805g-h with information, and query the status of a block of the blockchain 820 stored by the full nodes 805b-e and 805g-h. In this example, however, as shown in FIG. 8, the lightweight nodes 805a and 805f may not store a copy of the blockchain 820 and thus, may not publish new blocks on the blockchain 820.

Blockchain Network Types. The blockchain network 800 and its associated blockchain 820 may be public (permissionless), federated or consortium, or private. If the blockchain network 800 is public (like the blockchains A, B, in FIG. 1), then any entity may read and write to the associated blockchain 820. However, the blockchain network 800 and its associated blockchain 820 may be federated or consortium if controlled by a single entity or organization (like the private blockchain of FIG. 1). Further, any of the nodes 805 with access to the Internet may be restricted from participating in the verification of transactions on the blockchain 820. The blockchain network 800 and its associated blockchain 820 may be private (permissioned) if access to the blockchain network 800 and the blockchain 820 is restricted to specific authorized entities, for example organizations or groups of individuals. Moreover, read permissions for the blockchain 820 may be public or restricted while write permissions may be restricted to a controlling or authorized entity.

Blockchain. As discussed above, a blockchain 820 may be associated with a blockchain network 800. FIG. 9 shows an example blockchain 900. The blockchain 900 may comprise a plurality of blocks 905a, 905b, and 905c (generally referred to as blocks 905). The blockchain 900 comprises a first block (not shown), sometimes referred to as the genesis block. Each of the blocks 905 may comprise a record of one or a plurality of submitted and validated transactions. The blocks 905 of the blockchain 900 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 900 may be stored locally, in the cloud, on grid, for example by the nodes 805b-e and 805g-h, as a file or in a database.

Blocks. Each of the blocks 905 may comprise one or more data fields. The organization of the blocks 905 within the blockchain 900 and the corresponding data fields may be implementation specific. As an example, the blocks 905 may comprise a respective header 920a, 920b, and 920c (generally referred to as headers 920) and block data 975a, 975b, and 975c (generally referred to as block data 975). The headers 920 may comprise metadata associated with their respective blocks 905. For example, the headers 920 may comprise a respective block number 925a, 925b, and 925c. As shown in FIG. 9, the block number 925a of the block 905a is N−1, the block number 925b of the block 905b is N, and the block number 925c of the block 905c is N+1. The headers 920 of the blocks 905 may include a data field comprising a block size (not shown).

The blocks 905 may be linked together and cryptographically secured. For example, the header 920b of the block N (block 905b) includes a data field (previous block hash 930b) comprising a hash representation of the previous block N−1's header 920a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 920c of the block N+1 (block 905c) includes a data field (previous block hash 930c) comprising a hash representation of block N's (block 905b) header 920b.

The headers 920 of the blocks 905 may also include data fields comprising a hash representation of the block data, such as the block data hash 970a-c. The block data hash 970a-c may be generated, for example, by a Merkle tree and by storing the hash or by using a hash that is based on all of the block data. The headers 920 of the blocks 905 may comprise a respective nonce 960a, 960b, and 960c. In some implementations, the value of the nonce 960a-c is an arbitrary string that is concatenated with (or appended to) the hash of the block. The headers 920 may comprise other data, such as a difficulty target.

The blocks 905 may comprise a respective block data 975a, 975b, and 975c (generally referred to as block data 975). The block data 975 may comprise a record of validated transactions that have also been integrated into the blockchain 800 via a consensus model (described below). As discussed above, the block data 975 may include a variety of different types of data in addition to validated transactions. Block data 975 may include any data, such as text, audio, video, image, or file, that may be represented digitally and stored electronically.

Blockchain Transaction. In one example, a blockchain based transaction may generally involve a transfer of data or value or an interaction between entities and described in more detail below. Referring back to FIG. 7, the server 750 may include one or more applications, for example, a transaction application configured to facilitate a blockchain transaction between entities. The entities may include users, devices, etc. The first user 710 may request or initiate a transaction with the second user 715 via a user application executing on the first client device 720. The transaction may be related to a transfer of value or data from the first user 710 to the second user 715. The value or data may represent money, a contract, property, records, rights, status, supply, demand, alarm, trigger, or any other asset that may be represented in digital form. The transaction may represent an interaction between the first user 710 and the second user 715. As discussed above, the records of such interactions on the public blockchain ledger may be used to make user-to-user or other entity-to-entity associations for training or deploying a machine learning model.

FIG. 10 is a diagram of a transaction 1065 generated by the transaction application. The transaction 1065 may include a public key 1015, a blockchain address 1030 associated with the first user 110, a digital signature 1055, and transaction output information 1060. The transaction application may derive a public key 1015 from a private key 1005 of the first user 710 by applying a cryptographic hash function 1010 to the private key 1005. The cryptographic hash function 1010 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 710, such as the blockchain address 1030, by applying a hash function 1020 to the public key 1015. Briefly, a hash function is a function that may be used for mapping arbitrary size data to fixed size data. The value may also be referred to as a digest, a hash value, a hash code, or a hash. In order to indicate that the first user 710 is the originator of the transaction 1065, the transaction application may generate the digital signature 1055 for the transaction data 1035 using the private key 1005 of the first user 710. The transaction data 1035 may include information about the assets to be transferred and a reference to the sources of the assets, such as previous transactions in which the assets were transferred to the first user 710 or an identification of events that originated the assets. Generating the digital signature 1055 may include applying a hash function 1040 to the transaction data 1035 resulting in hashed transaction data 1045. The hashed transaction data 1045 and the transaction data 1035 may be encrypted (via an encryption function 1050) using the private key 1005 of the first user 710 resulting in the digital signature 1055. The transaction output information 1060 may include asset information 1050 and an address or identifier for the second user 1050, such as the blockchain address 1050. The transaction 1065 may be sent from the first client device 725 to the server 750.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

Blockchain Addresses. A blockchain network may utilize blockchain addresses to indicate an entity using the blockchain or start and end points in the transaction. For example, a blockchain address for the first user 710, shown in FIG. 10 as the blockchain address of sender 1030, may include an alphanumeric string of characters derived from the public key 1015 of the first user 710 based on applying a cryptographic hash function 1020 to the public key 1015. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

Broadcasting Transaction. The server 750 may receive transactions from users of the blockchain network 730. The transactions may be submitted to the server 750 via desktop applications, smartphone applications, digital wallet applications, web services, or other software applications. The server 750 may send or broadcast the transactions to the blockchain network 730. FIG. 11 shows an example transaction 1102 broadcast by the server 750 to the blockchain network 730. The transaction 1102 may be broadcast to multiple nodes 805 of the blockchain network 730. Typically, once the transaction 1102 is broadcast or submitted to the blockchain network 730, it may be received by one or more of the nodes 805. Once the transaction 1102 is received by the one or more nodes 805 of the blockchain network 730, it may be propagated by the receiving nodes 805 to other nodes 805 of the blockchain network 730.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcast to one or more specific nodes based on criteria related to the node's geography, history, reputation, market conditions, docket/delay, technology platform. The rules may be dynamically modified or updated (e.g. turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

Transaction Validation—User Authentication and Transaction Data Integrity. Not all the full nodes 805 may receive the broadcasted transaction 1102 at the same time, due to issues such as latency. Additionally, not all of the full nodes 805 that receive the broadcasted transaction 1102 may choose to validate the transaction 1102. A node 805 may choose to validate specific transactions, for example, based on transaction fees associated with the transaction 1102. The transaction 1102 may include a blockchain address 1105 for the sender, a public key 1110, a digital signature 1115, and transaction output information 1120. The node 805 may verify whether the transaction 1102 is legal or conforms to a pre-defined set of rules. The node 805 may also validate the transaction 1102 based on establishing user authenticity and transaction data integrity. User authenticity may be established by determining whether the sender indicated by the transaction 1102 is in fact the actual originator of the transaction 1102. User authenticity may be proven via cryptography, for example, asymmetric-key cryptography using a pair of keys, such as a public key and a private key. Additional factors may be considered when establishing user authenticity, such as user reputation, market conditions, history, transaction speed, etc. Data integrity of the transaction 1102 may be established by determining whether the data associated with the transaction 1102 was modified in any way. Referring back to FIG. 10, when the transaction application creates the transaction 1065, it may indicate that the first user 710 is the originator of the transaction 1065 by including the digital signature 1055.

The node 805 may decrypt the digital signature 1115 using the public key 1110. A result of the decryption may include hashed transaction data 1140 and transaction data 1130. The node 805 may generate hashed transaction data 1150 based on applying a hash function 1145 to the transaction data 1130. The node 805 may perform a comparison 1165 between the first hashed transaction data 1140 and the second hashed transaction data 1150. If the result 1170 of the comparison 1165 indicates a match, then the data integrity of the transaction 1102 may be established and node 805 may indicate that the transaction 1102 has been successfully validated. Otherwise, the data of the transaction 1102 may have been modified in some manner and the node 805 may indicate that the transaction 1102 has not been successfully validated.

Each full node 805 may build its own block and add validated transactions to that block. Thus, the blocks of different full nodes 805 may comprise different validated transactions. As an example, a full node 805a may create a first block comprising transactions “A,” “B,” and “C.” Another full node 805b may create a second block comprising transactions “C,” “D,” and “E.” Both blocks may include valid transactions. However, only one block may get added to the blockchain, otherwise the transactions that the blocks may have in common, such as transaction “C” may be recorded twice leading to issues such as double-spending when a transaction is executed twice. One problem that may be seen with the above example is that transactions “C,” “D,” and “E” may be overly delayed in being added to the blockchain. This may be addressed a number of different ways as discussed below.

Securing Keys. Private keys, public keys, and addresses may be managed and secured using software, such as a digital wallet. Private keys may also be stored and secured using hardware. The digital wallet may also enable the user to conduct transactions and manage the balance. The digital wallet may be stored or maintained online or offline, and in software or hardware or both hardware and software. Without the public/private keys, a user has no way to prove ownership of assets. Additionally, anyone with access a user's public/private keys may access the user's assets. While the assets may be recorded on the blockchain, the user may not be able to access them without the private key.

Tokens. A token may refer to an entry in the blockchain that belongs to a blockchain address. The entry may comprise information indicating ownership of an asset. The token may represent money, a contract, property, records, access rights, status, supply, demand, alarm, trigger, reputation, ticket, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. The person that owns the private key corresponding to the blockchain address may access the tokens at the address. Thus, the blockchain address may represent an identity of the person that owns the tokens. Only the owner of the blockchain address may send the token to another person. The tokens may be accessible to the owner via the owner's wallet. The owner of a token may send or transfer the token to a user via a blockchain 36ransacttion. For example, the owner may sign the transaction corresponding to the transfer of the token with the private key. When the token is received by the user, the token may be recorded in the blockchain at the blockchain address of the user.

Establishing User Identity. While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

Publishing and Validating a Block. As discussed above, full nodes 805 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 805 solves the puzzle, it may publish its block to be validated by the validation nodes 805 of the blockchain network 730.

In a proof of work consensus model, a node validates a transaction, for example, by running a check or search through the current ledger stored in the blockchain. The node will create a new block for the blockchain that will include the data for one or more validated transactions (see, e.g., block 975 of FIG. 9). In a blockchain implementation such as Bitcoin, the size of a block is constrained. Referring back to FIG. 9, in this example, the block will include a Previous Block Hash 930 representing a hash of what is currently the last block in the blockchain. The block may also include a hash 970 of its own transaction data (e.g., a so-called Merkle hash). According to a particular algorithm, all or selected data from the block may be hashed to create a final hash value. According to an embodiment of the proof of work model, the node will seek to modify the data of the block so that the final hash value is less than a preset value. This is achieved through addition of a data value referred to as a nonce 960. Because final hash values cannot be predicted based on its input, it is not possible to estimate an appropriate value for the nonce 960 that will result in a final hash value that is less than the pre-set value. Accordingly, in this embodiment, a computationally-intensive operation is needed at the node to determine an appropriate nonce value through a “brute force” trial-and-error method. Once a successful nonce value is determined, the completed block is published to the blockchain network for validation. If validated by a majority of the nodes in the block chain network, the completed block is added to the blockchain at each participating node. When a node's block is not added to the blockchain, the block is discarded and the node proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain. However, when a transaction is returned to the queue it causes a delay in completing the transaction. Reducing the time to complete a transaction may be important. A set of blockchain rules, or renumeration/compensation for a node to process the returned transaction may determine how a returned transaction is to treated going forward. When a transaction is put into a pool then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive for nodes to process a returned transaction. As an example, a service provider may identify a network of preferred miners based on geography or based on a volume discount perspective. The time to complete a transaction may be optimized by routing a returned transaction to specific preferred nodes. A transaction may be associated with an address that limits which of the preferred nodes will get to process the transaction if it is returned due to its inclusion in a discarded block. A value may be associated with the transaction so that it goes to preferred miners in a specific geographic location. Additionally, returned transactions may be processed based on pre-set rules. For example, a rule may indicate a commitment to process a specific number of returned transactions to receive additional incentive or compensation.

Blockchain Confirmations. After a block comprising a transaction is added to a blockchain, a blockchain confirmation may be generated for the transaction. The blockchain confirmation may be a number of blocks added to the blockchain after the block that includes the transaction. For example, when a transaction is broadcast to the blockchain, there will be no blockchain confirmations associated with the transaction. If the transaction is not validated, then the block comprising the transaction will not be added to the blockchain and the transaction will continue to have no blockchain confirmations associated with it. However, if a block comprising the transaction is validated, then each of the transactions in the block will have a 40lockchainn confirmation associated with the transaction. Thus, a transaction in a block will have one blockchain confirmation associated with it when the block is validated. When the block is added to the blockchain, each of the transactions in the block will have two blockchain confirmations associated with it. As additional validated blocks are added to the blockchain, the number of blockchain confirmations associated with the block will increase. Thus, the number of blockchain confirmations associated with a transaction may indicate a difficulty of overwriting or reversing the transaction. A higher valued transaction may require a larger number of blockchain confirmations before the transaction is executed.

Consensus Models. As discussed above, a blockchain network may determine which of the full nodes 805 publishes a next block to the blockchain. In a permissionless blockchain network, the nodes 805 may compete to determine which one publishes the next block. A node 805 may be selected to publish its block as the next block in the blockchain based on consensus model. For example, the selected or winning node 805 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, a node may publish the next block by being the first to solve a computationally intensive mathematical problem (e.g, the mathematical puzzle described above). The solution serves as “proof” that the node expended an appropriate amount of effort in order to publish the block. The solution may be validated by the full nodes before the block is accepted. The proof of work model, however, may be vulnerable to a 51% attack described below. The proof of stake model is generally less computationally intensive that the proof of work model. Unlike the proof of work model which is open to any node having the computational resources for solving the mathematical problem, the proof of stake model is open to any node that has a stake in the system. The stake may be an amount of cryptocurrency that the blockchain network node (user) may have invested into the system. The likelihood of a node publishing the next block may be proportional to its stake. Since this model utilizes fewer resources, the blockchain may forego a reward as incentive for publishing the next block. The round robin model is generally used by permissioned blockchain networks. Using this model, nodes may take turns to publish new blocks. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g. in the context of a corporate environment), a hybrid blockchain network may switch to be between completely or partially permissioned and permissionless. The network may switch based on various factors, such as latency, security, market conditions, etc.

Forks. As discussed above, consensus models may be utilized for determining an order of events on a blockchain, such as which node gets to add the next block and which node's transaction gets verified first. When there is a conflict related to the ordering of events, the result may be a fork in the blockchain. A fork may cause two versions of the blockchain to exist simultaneously. Consensus methods generally resolve conflicts related to the ordering of events and thus, prevent forks from occurring. In some cases, a fork may be unavoidable. For example, with a proof of work consensus model, only one of the nodes competing to solve a puzzle may win by solving its puzzle first. The winning node's block is then validated by the network. If the winning node's block is successfully validated by the network, then it will be the next block added to the blockchain. However, it may be the case that two nodes may end up solving their respective puzzles at the same time. In such a scenario, the blocks of both winning nodes may be broadcast to the network. Since different nodes may receive notifications of a different winning node, the nodes that receive notification of the first node as the winning node may add the first node's block to their copy of the blockchain. Nodes that receive notification of the second node as the winning node may add the second node's block to their copy of the blockchain. This results in two versions of the blockchain or a fork. This type of fork may be resolved by the longest chain rule of the proof of work consensus model. According to the longest chain rule, if two versions of the blockchain exist, then the network the chain with a larger number of blocks may be considered to be the valid blockchain. The other version of the blockchain may be considered as invalid and discarded or orphaned. Since the blocks created by different nodes may include different transactions, a fork may result in a transaction being included in one version of the blockchain and not the other. The transactions that are in a block of a discarded blockchain may be returned to a queue and wait to be added to a next block.

In some cases, forks may result from changes related to the blockchain implementation, for example, changes to the blockchain protocols and/or software. Forks may be more disruptive for permissionless and globally distributed blockchain networks than for private blockchain networks due to their impact on a larger number of users. A change or update to the blockchain implementation that is backwards compatible may result in a soft fork. When there is a soft fork, some nodes may execute the update blockchain implementation while other nodes may not. However, nodes that do not update to the new blockchain implementation may continue to transact with updated nodes.

A change to the blockchain implementation that is not backwards compatible may result in a hard fork. While hard forks are generally intentional, they may also be caused by unintentional software bugs/errors. In such a case, all publishing nodes in the network may need to update to the new blockchain implementation. While publishing nodes that do not update to the new blockchain implementation may continue to publish blocks according to the previous blockchain implementation, these publishing nodes may reject blocks created based on the new blockchain implementation and continue to accept blocks created based on the previous blockchain implementation. Therefore, nodes on different hard fork versions of the blockchain may not be able to interact with one another. If all nodes move to the new blockchain implementation, then the previous version may be discarded or abandoned. However, it may not be practical or feasible to update all nodes in the network to a new blockchain implementation, for example, if the update invalidates specialized hardware utilized by some nodes.

Blockchain Based Application: Cryptocurrency. Cryptocurrency is a medium of exchange that may be created and stored electronically in a blockchain, such as a the blockchain 130a in FIG. 1. Bitcoin is one example of cryptocurrency, however there are several other cryptocurrencies. Various encryption techniques may be used for creating the units of cryptocurrency and verifying transactions. As an example, the first user 110 may own 10 units of a cryptocurrency. The blockchain 130a may include a record indicating that the first user 110 owns the 10 units of cryptocurrency. The first user 110 may initiate a transfer of the 10 units of cryptocurrency to the second user 115 via a wallet application executing on the first client device 120. The wallet application may store and manage a private key of the first user 110. Examples of the wallet device include a personal computer, a laptop computer, a smartphone, a personal data assistant (PDA), etc.

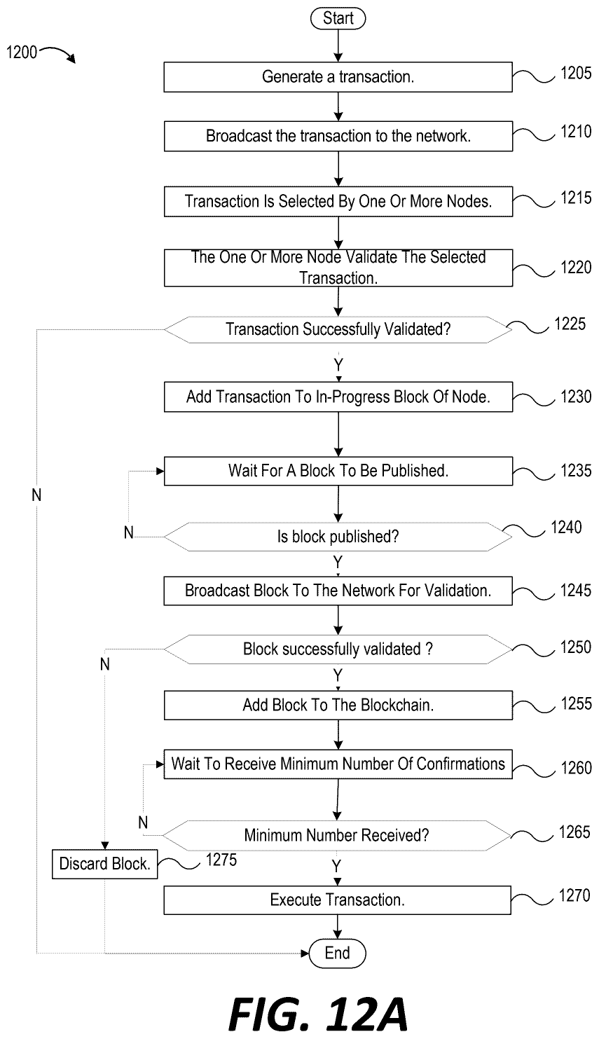

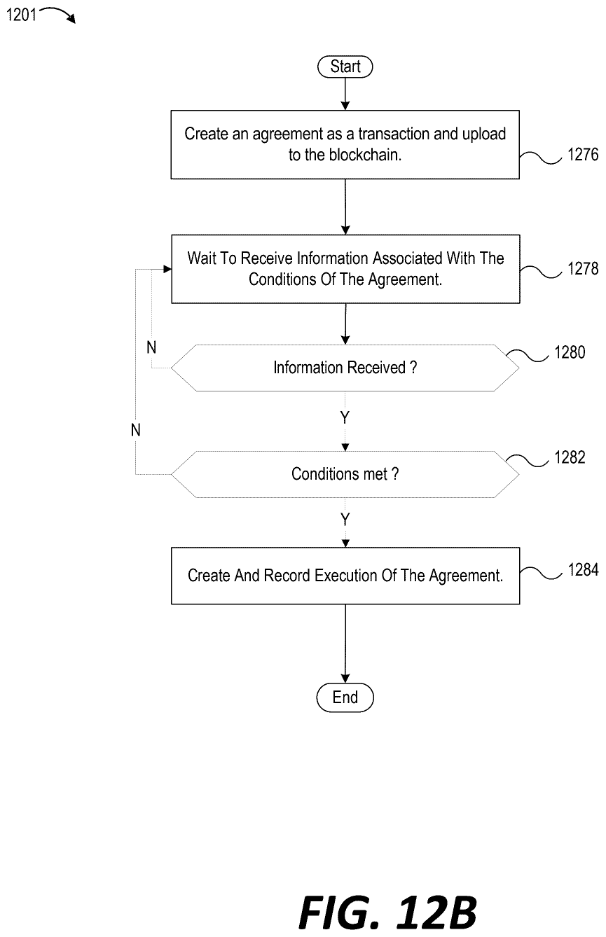

FIG. 12A is a flow diagram showing steps of an example method 1200 for performing a blockchain transaction between entities, such as the first user 110 of the first client device 120 and the second user 115 of the second client device 125 in FIG. 1. The steps of the method 1200 may be performed by any of the computing devices shown in FIG. 1. Alternatively or additionally, some or all of the steps of the method 1200 may be performed by one or more other computing devices. Steps of the method 1200 may be modified, omitted, and/or performed in other orders, and/or other steps added.

At step 1205, the wallet application may generate transaction data for transferring the 10 units of cryptocurrency from the first user 110 to the second user 120. The wallet application may generate a public key for the transaction using the private key of the first user 110. In order to indicate that the first user 110 is the originator of the transaction, a digital signature may also be generated for the transaction using the private key of the first user 110. As discussed with reference to FIG. 10, the transaction data may include information, such as a blockchain address of the sender 1030, the digital signature 1055, transaction output information 1060, and the public key of the sender 1015. The transaction data may be sent to the server 150 from the first client device 125.

The server 150 may receive the transaction data from the first client device 125. At step 1210, the server 150 may broadcast the transaction to the blockchain network 130a. The transaction may be received by one or more nodes 805 of the blockchain network 130a. At step 1215, upon receiving the transaction, a node 805 may choose to validate the transaction, for example, based on transaction fees associated with the transaction. If the transaction is not selected for validation by any of the nodes 805, then the transaction may be placed in a queue and wait to be selected by a node 805.

At step 1220, each of the nodes 805 that selected the transaction may validate the transaction. Validating the transaction may include determining whether the transaction is legal or conforms to a pre-defined set of rules for that transaction, establishing user authenticity, and establishing transaction data integrity. At step 1225, if the transaction is successfully validated by a node 805, the validated transaction is added to a block being constructed by that node 805. As discussed above, since different nodes 805 may choose to validate different transactions, different nodes 805 may build or assemble a block comprising different validated transactions. Thus, the transaction associated with the first user 110 transferring 10 units of cryptocurrency to the second user 115 may be included in some blocks and not others.

At step 1235, the blockchain network 130a may wait for a block to be published. Validated transactions may be added to the block being assembled by a node 805 until it reaches a minimum size specified by the blockchain. If the blockchain network 130a utilizes a proof of work consensus model, then the nodes 805 may compete for the right to add their respective blocks to the blockchain by solving a complex mathematical puzzle. The node 805 that solves its puzzle first wins the right to publish its block. As compensation, the winning node may be awarded a transaction fee associated with the transaction (e.g., from the wallet of the first user 110). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining.” At step 1240, if a block has not been published, then the process 1200 returns to step 1235 and waits for a block to be published. However, at step 1240, if a block has been published, then the process 1200 proceeds to step 1245.

At step 1245, the published block is broadcast to the blockchain network 130a for validation. At step 1250, if the block is validated by a majority of the nodes 805, then at step 1255, the validated block is added to the blockchain 820. However, at step 1250, if the block is not validated by a majority of the nodes 805, then the process 1200 proceeds to step 1275. At step 1275, the block is discarded and the transactions in the discarded block are returned back to the queue. The transactions in the queue may be selected by one or more nodes 805 for the next block. The node 805 that built the discarded block may build a new next block.

At step 1260, if the transaction was added to the blockchain 820, the server 150 may wait to receive a minimum number of blockchain confirmations for the transaction. At step 1265, if the minimum number of confirmations for the transaction have not been received, then the process may return to step 1260. However, if at step 1265, the minimum number of confirmations have been received, then the process proceeds to step 1270. At step 1270, the transaction may be executed and assets from the first user 110 may be transferred to the second user 115. For example, the 10 units of cryptocurrency owned by the first user 110 may be transferred from a financial account of the first user 110 to a financial account of the second user 115 after the transaction receives at least three confirmations.

Smart Contracts. A smart contract is an agreement that is stored in a blockchain and automatically executed when the agreement's predetermined terms and conditions are met. The terms and conditions of the agreement may be visible to other users of the blockchain. When the pre-defined rules are satisfied, then the relevant code is automatically executed. The agreement may be written as a script using a programming language such as Java, C++, JavaScript, VBScript, PHP, Perl, Python, Ruby, ASP, Tcl, etc. The script may be uploaded to the blockchain as a transaction on the blockchain.

As an example, the first user 110 (also referred to as tenant 110) may rent an apartment from the second user 115 (also referred to as landlord 115). A smart contract may be utilized between the tenant 110 and the landlord 115 for payment of the rent. The smart contract may indicate that the tenant 110 agrees to pay next month's rent of $1000 by the 28th of the current month. The agreement may also indicate that if the tenant 110 pays the rent, then the landlord 115 provides the tenant 110 with an electronic receipt and a digital entry key to the apartment. The agreement may also indicate that if the tenant 110 pays the rent by the 28th of the current month, then on the last day of the current month, both the entry key and the rent are released respectively to the tenant 110 and the landlord 115.

FIG. 12B is a flow diagram showing steps of an example method 1201 for performing a smart contract transaction between entities, such as the tenant 110 and the landlord 115. The steps of the method 1201 may be performed by any of the computing devices shown in FIG. 1. Alternatively or additionally, some or all of the steps of the method 1201 may be performed by one or more other computing devices. Steps of the method 1201 may be modified, omitted, and/or performed in other orders, and/or other steps added.

At step 1276, the agreement or smart contract between the tenant 110 and the landlord 115 may be created and then submitted to the blockchain network 130a as a transaction. The transaction may be added to a block that is mined by the nodes 805 of the blockchain network 130a, the block comprising the transaction may be validated by the blockchain network 130a and then recorded in the blockchain 820 (as shown in steps 1210-655 in FIG. 12A). The agreement associated with the transaction may be given a unique address for identification.

At step 1278, the process 1201 waits to receive information regarding the conditions relevant for the agreement. For example, the process 1201 may wait to receive notification that $1000 was sent from a blockchain address associated with the tenant 110 and was received at a blockchain address associated with the landlord 115 by the 28^{th} of the current month. At step 1280, if such a notification is not received, then the process 1201 returns to step 1278. However, if at step 1280, a notification is received, then the process 1201 proceeds to step 1282.

At step 1282, based on determining that the received notification satisfies the conditions needed to trigger execution of the various terms of the smart contract, the process 1201 proceeds to step 1284. However, at step 1282, if it is determined that the received notification does not satisfy the conditions needed to trigger execution of the smart contract, then the process 1201 returns to step 1278. At step 1283, the process 1201 creates a transaction associated with execution of the smart contract. For example, the transaction may include information of the payment received, the date the payment was received, an identification of the tenant 110 and an identification of the landlord 115. The transaction may be broadcast to the blockchain network 130a and recorded in the blockchain 820 (as shown in steps 1210-655 of the process 1200 of FIG. 12A). If the transaction is successfully recorded in the blockchain 820, the transaction may be executed. For example, if the payment was received on the 28^{th}, then an electronic receipt may be generated and sent to the tenant 110. However, on the last day of the current month, both the digital entry key and the rent are released respectively to the tenant 110 and the landlord 115.

Smart contracts may execute based on data received from entities that are not on the blockchain or off-chain resources. For example, a smart contract may be programmed to execute if a temperature reading from a smart sensor or IoT sensor falls below 10 degrees. Smart contracts are unable to pull data from off-chain resources. Instead, such data needs to be pushed to the smart contract. Additionally, even slight variations in data may be problematic since the smart contract is replicated across multiple nodes of the network. For example, a first node may receive a temperature reading of 9.8 degrees and a second node may receive a temperature reading of 10 degrees. Since validation of a transaction is based on consensus across nodes, even small variations in the received data may result in a condition of the smart contract to be evaluated as being not satisfied. Third party services may be utilized to retrieve off-chain resource information and push this to the blockchain. These third party services may be referred to as oracles. Oracles may be software applications, such as a big data application, or hardware, such as an IoT or smart device. For example, an oracle service may evaluate received temperature readings beforehand to determine if the readings are below 10 degrees and then push this information to the smart contract. However, utilizing oracles may introduce another possible point of failure into the overall process. Oracles may experience errors, push incorrect information or may even go out of business.

Since blockchains are immutable, amending or updating a smart contract that resides in a blockchain may be challenging and thus, more expensive and/or more restrictive than with text-based contracts.

Internet of Things (IoT). An IoT network may include devices and sensors that collect data and relay the data to each other via a gateway. The gateway may translate between the different protocols of the devices and sensors as well as manage and process the data. IoT devices may, for example, collect information from their environments such as motions, gestures, sounds, voices, biometic data, temperature, air quality, moisture, and light. The collected information sent over the Internet for further processing. Typically, IoT devices use a low power network, Bluetooth, Wi-Fi, or satellite to connect to the Internet or “the cloud”. Some IoT related issues that blockchain may be able to detect include a lack of compliance in the manufacturing stage of an IoT device. For example, a blockchain may track whether an IoT device was adequately tested.

As discussed above, information from off-chain resources, including IoT devices, may be pushed to smart contracts via third party entities known as oracles. As an example, a smart refrigerator may monitor the use of an item stored in the refrigerator, such as milk. Various sensors within the refrigerator may be utilized for periodically determining an amount of milk stored in the refrigerator. A smart contract stored in a blockchain may indicate that if the weight of the stored milk falls below 10 ounces, then a new carton of milk is automatically purchased and delivered. The refrigerator sensors may periodically send their readings to a third party service or oracle. The oracle may evaluate the sensor readings to determine whether the conditions for purchasing a new carton of milk have been met. Upon determining that the weight of the stored milk is below 10 ounces, the oracle may push information to the smart contract indicating that the condition for executing the smart contract has been met. The smart contract may execute and a new carton of milk may be automatically purchased. Both the execution of the smart contract and the purchase of the new carton may be recorded in the blockchain. In some cases, the condition may be an occurrence of an event, such as a need or anticipated need, or convenience factors, such as a delivery day, cost, promotions, or incentives.

Some issues related to the integration of blockchain into IoT include speed of transactions and computational complexity. The speed at which transactions are executed on the blockchain may be important when IoT networks with hundreds or thousands of connected devices are all functioning and transacting simultaneously. IoT devices are generally designed for connectivity rather than computation and therefore, may not have the processing power to support a blockchain consensus algorithm, such as proof of work. IoT devices also tend to be vulnerable to hacking via the Internet and/or physical tampering. For example, IoT devices may be more vulnerable to DDOS and malware attacks. Hackers may target a specific network and begin spamming the network with traffic within a short amount of time. Because of the increased surge in traffic, the bandwidth may be quickly overloaded, and the entire system may crash.

Supply Chain Monitoring and Logistics. A supply chain for a product may include a network of entities and activities that are involved in the creation of the product and its eventual sale to a customer. A blockchain based record of the supply chain for a product may be utilized, for example, to trace the provenance of parts and materials and to prevent counterfeit parts from entering the supply chain. Blockchain integration into the supply chain for a product may utilize IoT devices and data, oracles, and smart contracts. For example, an RFID tag may be attached to a product in order to physically track the product and record its location within the supply chain. Additionally, smart contracts may be utilized to record the various activities and interactions between entities that are involved in the product's supply chain. As discussed above with reference to FIGS. 12A and 12B, any data or information that may be digitally represented and electronically stored may be recorded in a blockchain by submitting the data as part of a blockchain transaction. When the transaction is included in a validated block that is added to the blockchain, the transaction and its associated data is recorded in the blockchain.

As an example, a permissioned blockchain may be utilized for recording and monitoring the entities and activities involved in food distribution, such as fruit or vegetables. The blockchain may be accessible to entities, such as the suppliers of seed and pesticides, farmers, distributors, grocery stores, customers, and regulators. The blockchain may record activities such as the sale of a pesticide and/or seed to the farmer, the harvesting and packaging of the fruit, its shipment to distributors' warehouses, its arrival at various stores, and eventual purchase by a consumer. Sensors and RFID devices may be utilized for tracking the fruit through the supply chain. For example, the fruit may be packaged in crates tagged with a unique RFID device. When the tagged crate is loaded onto a truck for shipment from the farm to a distributor, the crate may be scanned and a record of its shipment may be uploaded to the blockchain. When the crate arrives at a warehouse, it may be scanned again and a record of its arrival at the warehouse may be uploaded to the blockchain. Additionally, smart contracts may be executed throughout the supply chain. For example, when the crate is scanned at the warehouse, a smart contract between the farmer and the warehouse may be executed indicating that the crate was successfully shipped from the farmer to the warehouse and received by the warehouse.

As another example, a permissioned blockchain for an automobile may store a record of entities and activities related to a component that is utilized in the manufacturing of the automobile. The blockchain may be accessible to various entities, such as automobile OEMs, distributors and suppliers of materials and components, dealerships, mechanics, insurance providers, and others. While evaluating an accident involving a policy holder's automobile, an insurance provider 110 may determine that the accident may have been caused by a defective component used in a wheel of the automobile. The insurance provider 110 may wish to trace a provenance of the component based on information recorded in the permissioned blockchain. The insurance provider 110 may query the blockchain data for information related to the component via, for example, a blockchain querying application executing on the first client device 120. The query may include identifying information associated with the component. For example, the component may be marked with an identification that is unique to the component or a group of components. The results of the query may include records in the blockchain of the entities and activities that were involved in the creation of the component and its eventual sale to the automobile manufacturer.

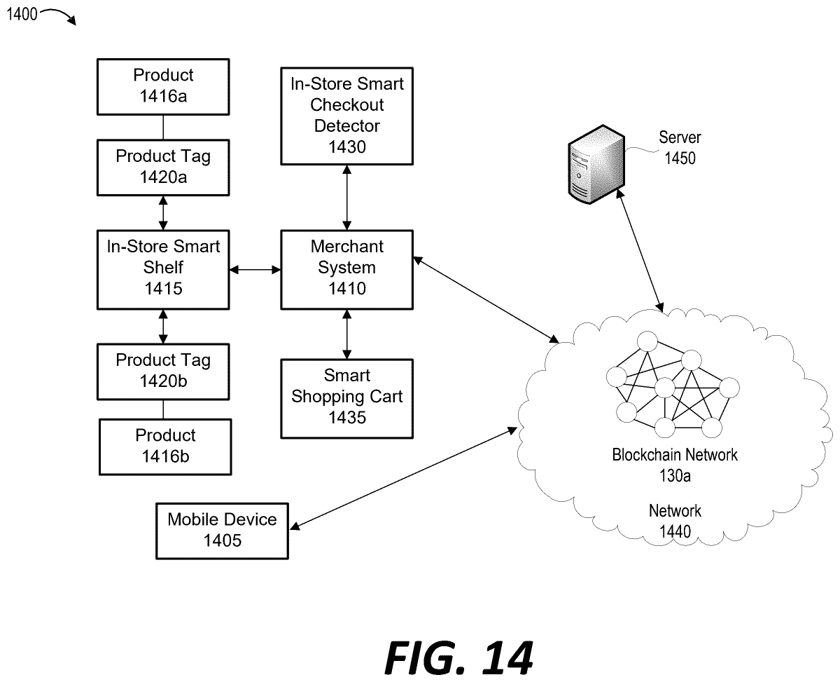

Blockchain Enabled In-Store Purchasing. An example of blockchain enabled in-store purchasing is described with reference to the system 1400 shown in FIG. 14, the process 1200 shown in FIG. 12A and the process 1201 shown in FIG. 12B. FIG. 14 illustrates an example of a blockchain enabled in-store purchase system 1400. The system 1400 includes a mobile device 1405, a merchant system 1410, and a server 1450 connected via a network 1440. The merchant system 1410 may be connected via a local wireless network to various IoT devices within a store, for example, an in-store smart shelf 1415, and an in-store smart checkout detector 1430.

The store may include one or more smart shelves, such as the in-store smart shelf 1415. The smart shelf 1415 may include an RFID tag, an RFID reader, and an antenna. One or more products may be stored on the in-store smart shelf 1415. Each product may include an RFID tag, such as a first product tag 1420a attached to a first product 1416a and a second product tag 1420b attached to a second product 1416b. The in-store smart shelf 1415 may, based on reading the product tags 1420a and 1420b, send information about the products 1416a and 1416b throughout the day to the merchant system 1410. The merchant system 1410 may in turn update an inventory of products currently within the store.

A shopper may travel through the store with the mobile device 1405. A digital shopping list on the mobile device 1405 may include a list of items that the shopper may need to purchase. For example, the shopping list may include an item that matches the first product 1416a. When the shopper is close to the in-store smart shelf 1415, the mobile device 1405 may notify the shopper that the first product 1416a is currently available on the in-store smart shelf 1415. The shopper may remove the first product 1416a from the in-store smart shelf 1415 and place it into a smart shopping cart 1435. The smart shopping cart 1435 may read the first product tag 1420a as well as the product tags attached to other products that may have been placed in the smart shopping cart 1435. When the shopper is ready to checkout, the shopper may walk out of the store with the shopping cart 1435. As the shopper walks out of the store, the in-store smart checkout detector 1430 may detect the smart shopping cart 1435. The smart shopping cart 1435 may communicate with the in-store smart checkout detector 1430 and transmit information about the products in the smart shopping cart. The in-store smart checkout detector 1430 may send information about the products, such as the first product 1416a, and payment information from the mobile device 1405 to the merchant system 1410. The merchant system 1410 may receive information from the in-store smart checkout detector 1430 and the payment information and proceed to initiate purchase of the first product 1416a.

Referring to step 1205 of the process 1200 shown in FIG. 12A, a wallet application on the mobile device 1405 may generate transaction data for transferring an amount of cryptocurrency matching the sale price of the first product 1416a from the shopper to the merchant. The wallet application may generate a public key for the transaction using the private key of the shopper. In order to indicate that the shopper is the originator of the transaction, a digital signature may also be generated for the transaction using the private key of the shopper. The transaction data may be sent to the server 1450 from the mobile device 1405.

The server 1450 may receive the transaction data from the mobile device 1405. At step 1210, the server 1450 may broadcast the transaction to the blockchain network 130a. The transaction may be received by one or more nodes 805 of the blockchain network 130a. At step 1215, upon receiving the transaction, a node 805 may choose to validate the transaction, for example, based on transaction fees associated with the transaction. If the transaction is not selected for validation by any of the nodes 805, then the transaction may be placed in a queue and wait to be selected by a node 805.

At step 1220, each of the nodes 805 that selected the transaction may validate the transaction. At step 1225, if the transaction is successfully validated by a node 805, the validated transaction is added to a block being constructed by that node 805. At step 1235, the blockchain network 130a may wait for a block to be published. At step 1240, if a block has not been published, then the process 1200 returns to step 1235 and waits for a block to be published. However, at step 1240, if a block has been published, then the process 1200 proceeds to step 1245.

At step 1245, the published block is broadcast to the blockchain network 130a for validation. At step 1250, if the block is validated by a majority of the nodes 805, then at step 1255, the validated block is added to the blockchain 820. At step 1260, if the transaction was added to the blockchain 820, the server 1450 may wait to receive a minimum number of blockchain confirmations for the transaction. At step 1265, if the minimum number of confirmations for the transaction have not been received, then the process may return to step 1260. However, if at step 1265, the minimum number of confirmations have been received, then the process proceeds to step 1270. At step 1270, the transaction may be executed and the sale price of the first product 1416a may be transferred from the shopper to the merchant.

When the in-store smart checkout detector 1430 sends information about the products, such as the first product 1416a, and payment information from the mobile device 1405 to the merchant system 1410, a smart contract may be created between the shopper and the merchant and executed according to the process 1201 shown in FIG. 12B. For example, at step 1276, a smart contract between the shopper and the merchant may be created and then submitted to the blockchain network 130a as a transaction. For example, at step 1278, the process 1201 may wait to receive notification that an amount of cryptocurrency equal to the sale price of the first product 1416a was sent from a blockchain address associated with the shopper and was received at a blockchain address associated with the merchant by the time the first product 1416a is removed from the smart shopping cart 1435. If the payment for the first product 1416a was successfully transferred from the shopper to the merchant by the time the shopper removes the first product 1416a from the smart shopping cart 1435, then an electronic receipt may be generated and sent to the shopper. Otherwise, the merchant system 1415 may be alerted that the shopper is attempting to leave the premises without paying for the first product 1416a.

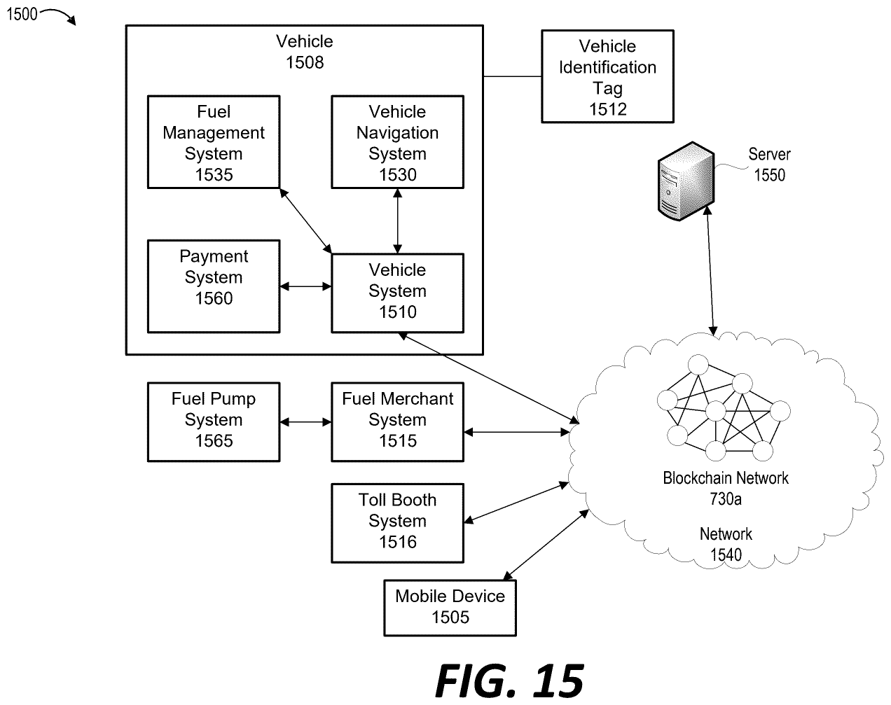

Blockchain Enabled In-Vehicle Purchasing. An example of blockchain enabled in-vehicle purchasing is described with reference to the system 1500 shown in FIG. 15, the process 1200 shown in FIG. 12A and the process 1201 shown in FIG. 12B. FIG. 15 illustrates an example system 1500 for blockchain enabled in-vehicle purchasing. The system 1500 includes an IoT enable smart vehicle 1508. The vehicle 1508 may include one or more computing devices implementing a vehicle system 1510, a vehicle navigation system 1530, a payment system 1560 and a fuel management system 1535. The vehicle 1508 may include a RFID tag, such as a vehicle identification tag 1512. The system 1500 may also include various merchant systems, such as a fuel merchant system 1515, and a toll booth system 1516. The system 1500 may also include a mobile device 1505 belonging to a driver of the vehicle 1508.

When the driver gets into the vehicle 1508, payment information may be loaded from the driver's mobile device 1505 into the vehicle payment system 1510 so it is available for secure payments to other devices in order to complete in-vehicle purchases, such as in-vehicle purchase of fuel and in-vehicle payment of tolls. The driver of the smart vehicle may pay for parking, fast food, using the IoT enabled smart vehicle 1508. Additionally, the IoT enabled smart vehicle 1508 may also facilitate in-vehicle purchasing of smartphone apps, music, audio books, and other goods and services.

The fuel management system 1535 may perform various functions related to fuel usage and communicate with the vehicle system 1516. For example, the fuel management system 1535 may monitor fuel usage and based on detecting that the fuel is below a threshold, notify the vehicle system 1510. The vehicle system 1510 may communicate with the vehicle navigation system 1530 to determine nearby fuel stations. The selection of a fuel station to may be based on various factors, such as the availability of fuel at nearby fuel stations, the vehicle's current route and location, incentives that may be offered by nearby fuel stations, etc. The vehicle system 1510 may notify the driver about the selection of a fuel station and the vehicle 1508 may be re-routed to the selected fuel station. Upon arriving at the selected fuel station, the driver may pull up to a fuel pump. The fuel pump may include a fuel pump system 1565 configured to detect the RFID tags of vehicles, such as the vehicle identification tag 1512 in order to obtain an identification of the vehicles. The fuel pump system 1565 and the payment system 1560 may be configured to communicate with each other. The fuel payment system 1560 may send payment information to the fuel pump system 1565. After the driver has completed re-fueling, the driver may simply drive away. The fuel pump system 1565 may send the fuel merchant system 1515 information about the identification of the vehicle 1508, the amount of fuel purchased, and the payment information. The fuel merchant system 1515 may use the information to complete a transaction with the driver for the purchase of the fuel. For example, the fuel merchant system 1515 may communicate with the server 1550 to charge the driver for the fuel according to the process 1200 shown in FIG. 12A. Additionally, the fuel merchant system 1515 may communicate with the server 1550 in order to create a smart contract between the driver and the fuel merchant. The smart contract may be created and executed according to the process 1201 shown in FIG. 12B.

Augmented Reality (AR), Mixed Reality and Blockchain Based E-Commerce. AR or mixed reality enabled devices, such as wearable smart glasses, head mounted devices, holographic devices, or smartphone applications overlay digital content on top of a real world view, thus, enhancing a user's experience of the real world. The overlay content may be 3D models generated based on 3D scanning real world objects. AR enables users to experience online shopping in a virtual environment. For example, using AR, browse virtual stores and view 3D models of items for sale in virtual stores. Just as in the real world, customers may be able to handle and examine various physical details of the products. Blockchain smart contracts may be utilized to provide an e-commerce platform where customers may purchase items from online merchants with cryptocurrency and digital wallets. Information about a product, such as country of origin, materials, ingredients, price, description, measurements, terms and conditions, 3D model of the physical product, etc., may be hashed and recorded in a blockchain. This provides proof of ownership of virtual goods and products and enables accurate tracking of any changes made to this information. Artificial intelligence (AI) may be utilized for generating 3D models of products based on 2D images of the products. Smart contracts may be utilized to conduct transactions between merchants and customers.

As an example, a customer may shop for clothing by browsing different stores in a virtual shopping mall via a wearable AR device, such as a pair of smart glasses. The customer may examine a 3D model of a shirt as he or she would in the real world. Additionally, the customer may virtually try on the shirt using a 3D model of the customer's body. If the customer decides to purchase the shirt, the customer may initiate a transaction with the merchant of the store. A transaction may be submitted to the blockchain via the customer's digital wallet to transfer money (cryptocurrency) from the customer to the merchant. Various smart contracts may be utilized to implement various aspects of the e-commerce process. For example, based on detecting that the sale price of the shirt has been successfully transferred from the customer to the merchant, a smart contract may be executed to initiate shipment of the shirt from the merchant's warehouse to the customer. As described above with reference to supply chain monitoring and tracking, RFID tags and other IoT devices may be utilized to track the shipment of the shirt from the merchant's warehouse to the delivery of the shirt to the customer's residence.

Quantum Computing. One of the concerns of quantum computing is that it may increase the probability of breaking cryptographic algorithms and thus, weaken overall security for the blockchain. This may be addressed by requiring larger key sizes for blockchain asymmetric-key pairs of cryptographic algorithms. In some cases, if there is a concern that a block may be decrypted in the future, a dynamically changing cryptographic hash may be utilized. A different cryptographic hash may be dynamically selected for a particular block or the entire blockchain based on various factors, such as whether there is a concern that the block will be decrypted in the future, increasing a strength of the hash, utilizing a hash that is better suited for protecting privacy. In some cases, different cryptographic hashes may be selected for different blocks.

Anonymity and Privacy. As discussed above, the use of a private/public key pair to establish user authenticity during validation of a blockchain transaction provides some privacy as it does not reveal user identity. However, the transactions stored on a blockchain may be visible to the public. It has been shown that user identity may be derived from the publicly available transaction information.

Blockchain Size. Depending on a frequency at which events are recorded in a blockchain, the size of the blockchain may grow quickly. Computing/storage capacity (i.e., faster processors, larger storage components) may be needed to support the expansion of the blockchain. In some cases, blocks may be compressed prior to being added to the chain. In some cases, blocks may be eliminated, for example, at the beginning of the blockchain, when they become stale or irrelevant. As an example, a method for “replacing” the first 1000 transactions with a new block that effectively mimics the hash of the 1000 transactions may be useful for managing blockchain size.

Blockchain Immutability. In some cases, content in a blockchain may need to be deleted. For example, content may need to be deleted if there is a security breach or if the content is no longer relevant. A level of immutability of a blockchain may depend on a type of the blockchain. For example, changing content may be difficult in a public blockchain due to its possible impact on a large number of users. According to some techniques, data stored in a private blockchain, or a public blockchain controlled by a few entities may be changed by recording a flag (current block) where the change is being made, and adding the current block (referred to by the flag) to the blockchain. The added block may then indicate the change made to the previous block.

As another example, a blockchain may need to be changed to resolve a broken link. For example, the hash of a changed block may no longer match the hash stored in the block+1. In some cases, the blockchain may need to be changed in order to reverse the results of illegal transactions. In some cases, the blockchain may need to be changed to address software errors, erroneous transactions, or remove information that is confidential or required by law to be removed. If the blockchain is immutable, these errors and information may be permanently embedded in the blockchain. Additionally, the blockchain may need to be changed to comply with regulatory concerns, such as the European Union's incoming General Data Protection Regulation (GDPR), or California Consumer Privacy Act (CCPA), regarding consumer data privacy and ownership rights, US Fair Credit Reporting Act, and the SEC's “Regulation SP,” which require that recorded user identifiable personal financial data be redactable.

Some techniques may allow modifications to the blockchain to address software errors, legal and regulatory requirements, etc., by allowing designated authorities to edit, rewrite or remove previous blocks of information without breaking the blockchain. Such techniques may enable blockchain editing by using a variation of a “chameleon” hash function, through the use of secure private keys. This editing may allow smart contracts that were flawed at issue to be updated so that the changes carry over to subsequent smart contracts in the blockchain. Using these techniques, blocks that have been changed may be using a “scar” or mark that cannot be removed, even by trusted parties.

According to some techniques, when a block is hashed, any confidential information, such as personally identifiable information, and IP addresses, is not included in the hash because it is not part of the data values that were hashed. But because there is no hash of the confidential information, it may be changed. According to some techniques, the confidential information may not be placed or recorded into the blockchain. Rather the information may reside in a file that is external to the blockchain. A hash of that file, however, may be recorded in the blockchain. For example, a user's confidential information may be deleted locally without affecting the blockchain.

As another example, assuming that all content included in a block in a blockchain cannot be changed after a block is added to the blockchain, a determination may be made before adding data to the blockchain of whether some or all of that data may need to be deleted at a later time. For example, confidential information (i.e., data to be deleted at a later time) may be stored as a file that is external to the block and the blockchain. For the purposes of creating the block, a link to the file containing the confidential information and a hash of the file containing the confidential information file may be added to the block. An example of a link would be an HTTP link. During confirmation of the block that is to be added to the blockchain, the network nodes may be able to access the confidential information and verify that the confidential information based on the hash value of the file in the block. Because the hash value of the file is a part of the block, the file containing the confidential information may not be easily changed. However, it may be possible to change the confidential information file by changing the data therein and adding a nonce. This may seek to change the nonce until the resulting hash equals the hash that is stored in the blockchain. However, this would be difficult (probably near impossible), and an inspection of the modified confidential information file would reveal the added nonce, which may then raise suspicion that information was changed since it was first added to the blockchain.

Files containing confidential information may be encrypted (e.g., through an asymmetric key encryption function) prior to the hashing operation. When “deleting” the confidential information, the file containing the confidential information may be deleted or removed resulting in the link, which is stored in the blockchain, being ineffective for retrieving the file. The hash of the file, and the link, remain in the blockchain so that the linking of the blocks through hash functions is not affected. However, because of this change, a transaction that is part of the block or part of a different special block could be added to the blockchain to indicate that the link is no longer effective and the confidential information file is no longer part of the blockchain. This may effectively keep confidential information out of the blockchain while providing the confidential information to users of the blockchain and proof of authenticity of the confidential information before it is deleted from the blockchain. This may come with drawbacks because access to data implies that such data may be stored. Accordingly, those with access to the confidential information file, while it was part of the blockchain, may have stored that information in another location that may no longer be reachable during the “deleting” operation discussed above.

51% attack. A “51% attack” refers to an individual mining node or a group of mining nodes controlling more than 50% of a blockchain network's mining power, also known as hash rate or hash power. The hash rate is a measure of the rate at which hashes are being computed on the blockchain network. As described above, hashing may include taking an input string of a given length, and running it through a cryptographic hash function in order to produce an output of a fixed length. A blockchain network's hash rate may be expressed in terms of 1 KH/s (kilohash per second) which is 1,000 hashes per second, 1 MH/s (megahash per second) which is 1,000,000 hashes per second, 1 TH/s (terahash per second) which is 1,000,000,000,000 hashes per second, or 1 PH/s (petahash per second) which is 1,000,000,000,000,000 hashes per second. As an example, a mining node in a blockchain utilizing a proof of work consensus model (PoW) may perform hashing in order to find a solution to a difficult mathematical problem. The hash rate of the mining node may depend on the computational resources available to that node. A mining node that successfully solves the mathematical problem may be able to add a block to the blockchain. Thus, by ensuring that invalid transactions cannot be included in a block, mining nodes increase the reliability of the network. Transactions may be deemed invalid if they attempt to spend more money than is currently owned or engage in double-spending. If a mining node intentionally or unintentionally includes an invalid transaction in a block, then the block will not be validated by the network. Additionally, nodes that accept the invalid block as valid and proceed to add blocks on top of the invalid block will also end up wasting computational resources. Thus, mining nodes are discouraged from cheating by intentionally adding invalid transactions to blocks and accepting invalid blocks as valid.

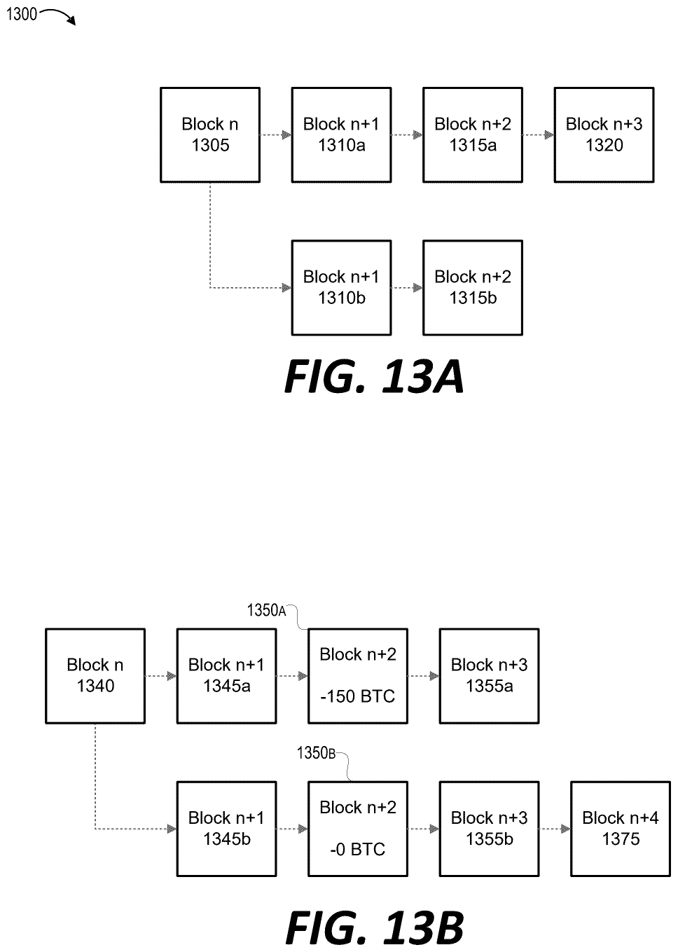

An entity may be able to disrupt the network by gaining control of 50% of a network's hash rate. In a 51% attack, a blockchain node may intentionally reverse or overwrite transactions and engage in double-spending. When a node generates a valid block of transactions, it broadcasts the block to the network for validation. In some cases, a node controlling more than 50% of a network's hash rate may mine blocks in private without broadcasting them to the network. In such a scenario, the rest of the network may follow a public version of the blockchain while the controlling node may be following its private version of the blockchain. FIG. 13A shows a fraudulent and valid version of a blockchain. The valid blockchain on the top comprises the valid blocks 1305, 1310a, 1315a, and 1320. The fraudulent blockchain on the bottom is not broadcast to the network and includes the blocks 1305, 1310b, 1315b, and an invalid block 1320.

FIG. 13B shows another fraudulent and valid version of a blockchain. The valid version of the blockchain includes nodes 1340, 1345a, 1350a, and 1355a. The fraudulent version of the blockchain includes nodes 1340, 1345b, 1350b, 1355b, and 13135. However, following the longest chain rule, the network may select and utilize the private or fraudulent blockchain comprising nodes 1340, 1345b, 1350b, 1355b and 1375. Since it is the longest chain, previous transactions may be updated according to this chain. The cheating node may include transactions that spend money, such as the block 1350b including the transaction for 150 BTC, on the public or fraudulent version of the blockchain without including these transactions in the private version of the blockchain. Thus, in the private version of the blockchain, the cheating node may continue to own the spent 150 BTC. When the cheating node controls more than 50% of the hashing resources of the network, it may able to broadcast its private version of the blockchain and continue to create blocks on the private blockchain faster than the rest of the network, thus, resulting in a longer blockchain. Since there are two versions of the blockchain, the network may select the longest or fraudulent private blockchain as the valid blockchain. As a result, the rest of the network may be forced to use the longer blockchain. The public or valid version of the blockchain may then be discarded or abandoned and all transactions in this blockchain that are not also in the private or fraudulent version of the blockchain may be reversed. The controlling or cheating node may continue to own the spent money because the spending transactions are not included on the fraudulent version of the blockchain, and the cheating node may therefore, spend that money in future transactions.

Because of the financial resources needed to obtain more hashing power than the rest of the entire network combined, a successful 51% attack may generally be challenging to achieve. However, it would be less expensive to achieve a 51% attack on a network with a lower hash rate than one with a higher has rate. Additionally, the probability of a successful 51% attack increases with the use of mining pools in which multiple nodes may combine their computational resources, for example, when mining is performed from the same mempool.

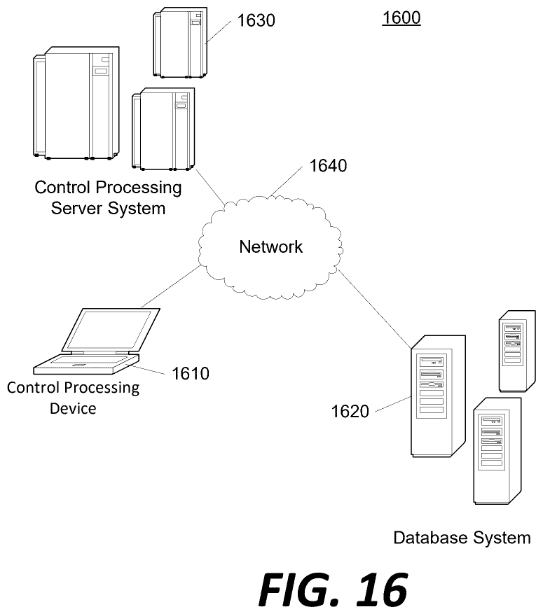

Computing Device. FIG. 16 shows a system 1600. The system 1600 may include at least one client device 1610, at least one database system 1620, and/or at least one server system 1630 in communication via a network 1640. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 16.

Client device 1610 may access server applications and/or resources using one or more client applications (not shown) as described herein. Client device 1610 may be a mobile device, such as a laptop, smart phone, mobile phones, or tablet, or computing devices, such as a desktop computer or a server, wearables, embedded devices. Alternatively, client device 1610 may include other types of devices, such as game consoles, camera/video recorders, video players (e.g., incorporating DVD, Blu-ray, Red Laser, Optical, and/or streaming technologies), smart TVs, and other network-connected appliances, as applicable.

Database system 1620 may be configured to maintain, store, retrieve, and update information for server system 1630. Further, database system may provide server system 1630 with information periodically or upon request. In this regard, database system 1620 may be a distributed database capable of storing, maintaining, and updating large volumes of data across clusters of nodes. Database system 1620 may provide a variety of databases including, but not limited to, relational databases, hierarchical databases, distributed databases, in-memory databases, flat file databases, XML databases, NoSQL databases, graph databases, and/or a combination thereof.

Server system 1630 may be configured with a server application (not shown) that is capable of interfacing with client application and database system 1620 as described herein. In this regard, server system 1630 may be a stand-alone server, a corporate server, or a server located in a server farm or cloud-computer environment. According to some examples, server system 1630 may be a virtual server hosted on hardware capable of supporting a plurality of virtual servers.

Network 1640 may include any type of network. For example, network 1640 may include a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies.

The data transferred to and from various computing devices in a system 1600 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 1600. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 1600 in front of one or more computing devices such that any external devices may communicate directly with the specialized hardware.

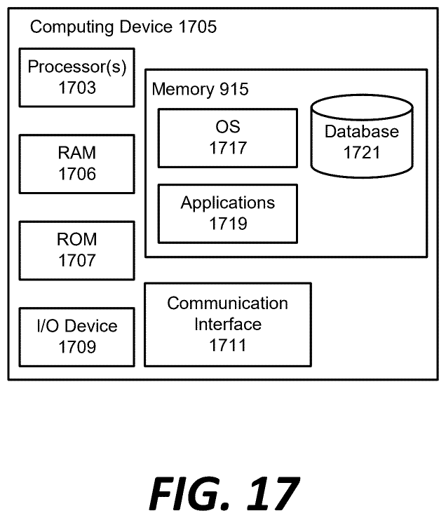

Turning now to FIG. 17, a computing device 1705 that may be used with one or more of the computational systems is described. The computing device 1705 may include a processor 1703 for controlling overall operation of the computing device 1705 and its associated components, including RAM 1705, ROM 1707, input/output device 1711, communication interface 1711, and/or memory 1715. A data bus may interconnect processor(s) 1703, RAM 1705, ROM 1707, memory 1715, I/O device 1709, and/or communication interface 1711. In some embodiments, computing device 1706 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 1709 may include a microphone, keypad, touch screen, and/or stylus motion, gesture, through which a user of the computing device 1700 may provide input, and may also include one or more of a speaker for providing audio output and a video display device for providing textual, audiovisual, and/or graphical output. Software may be stored within memory 1715 to provide instructions to processor 1703 allowing computing device 1700 to perform various actions. For example, memory 1715 may store software used by the computing device 1700, such as an operating system 1717, application programs 1719, and/or an associated internal database 1721. The various hardware memory units in memory 1715 may include volatile and nonvolatile, removable and non-removable media implemented in any method or technology for storage of information such as computer-readable instructions, data structures, program modules, or other data. Memory 1715 may include one or more physical persistent memory devices and/or one or more non-persistent memory devices. Memory 1715 may include, but is not limited to, random access memory (RAM) 1705, read only memory (ROM) 1707, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 1703.

Communication interface 1711 may include one or more transceivers, digital signal processors, and/or additional circuitry and software for communicating via any network, wired or wireless, using any protocol as described herein.

Processor 1703 may include a single central processing unit (CPU), which may be a single-core or multi-core processor, or may include multiple CPUs. Processor(s) 1703 and associated components may allow the computing device 1700 to execute a series of computer-readable instructions to perform some or all of the processes described herein. Although not shown in FIG. 17, various elements within memory 1715 or other components in computing device 1700, may include one or more caches, for example, CPU caches used by the processor 1703, page caches used by the operating system 1717, disk caches of a hard drive, and/or database caches used to cache content from database 1761. For embodiments including a CPU cache, the CPU cache may be used by one or more processors 1703 to reduce memory latency and access time. A processor 1703 may retrieve data from or write data to the CPU cache rather than reading/writing to memory 1715, which may improve the speed of these operations. In some examples, a database cache may be created in which certain data from a database 1721 is cached in a separate smaller database in a memory separate from the database, such as in RAM 1705 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 1705 are described separately, functionality of the various components may be combined and/or performed by a single component and/or multiple computing devices in communication without departing from the invention.

In a first aspect of the present disclosure, a computer-implemented method is provided. The method includes collecting, by a computing system, information respective of one or more transactions stored on a public blockchain, determining, by the computing system, that a first private account hosted by the computing system is associated with a first transaction of the one or more transactions, determining, by the computing system, that a second private account hosted by the computing system is associated with a second transaction of the one or more transactions, associating, by the computing system, the first private account with the second private account based on a connection of the first transaction to the second transaction on the public blockchain, and training, by the computing system, a machine learning model according to the association of the first private account with the second private account.

In an embodiment of the first aspect, determining that the first private account is associated with the first transaction comprises determining that the first transaction was conducted through a digital wallet hosted by the computing system and associated with the first private account. In a further embodiment of the first aspect, determining that the second private account is associated with the second transaction comprises determining that the second transaction was conducted through a digital wallet hosted by the computing system and associated with the second private account. In a further embodiment of the first aspect, determining that the first transaction was conducted through the digital wallet associated with the first private account comprises determining that a transactor address hash found on the public blockchain for a transaction matches a transactor address hash in the digital wallet associated with the first private account.

In an embodiment of the first aspect, the first transaction is the second transaction.

In an embodiment of the first aspect, the first transaction involves a first user of the first private account and a third user, the second transaction involves a second user of the second private account and a fourth user, a third transaction of the one or more transactions involves the third user and the fourth user, and the third transaction comprises the connection of the first transaction and the second transaction.

In an embodiment of the first aspect, training the machine learning model according to the association of the first private account with the second private account includes adding an edge between a node respective of the first private account and a node respective of the second private account to a graph and training a graph neural network according to the graph, or adding the association to a training data set and training a machine learning classifier according to the data set.

In an embodiment of the first aspect, training the machine learning model is further according to transactions on a private blockchain hosted by the computing system and involving the first private account or the second private account, and inter-party transactions involving the first private account or the second private account and performed through the computing system.

In a second aspect of the present disclosure, a computing system is provided that includes a processor and a computer-readable memory storing instructions. When executed by the processor, the instructions cause the computing system to perform operations including accessing a machine learning model trained on one-to-one associations between private user accounts hosted by a service operating the computing system, the one-to-one associations established according to information respective of a plurality of transactions stored on a public blockchain, the plurality of transactions involving the user accounts, applying the machine learning model to a plurality of entities to classify each of the plurality of entities as trusted or untrusted, and processing a requested computing action involving one of the entities based on the classification of the one of the entities as trusted or untrusted.

In an embodiment of the second aspect, each of the plurality of entities includes a user, an IP address, a physical address, or a device identifier.

In an embodiment of the second aspect, the one-to-one associations between the private user accounts are determined according to a plurality of the transactions in which the private user accounts transacted with each other.

In an embodiment of the second aspect, the one-to-one associations between the private user accounts are determined according to a plurality of the transactions in which the private user accounts transacted with a common third party.

In an embodiment of the second aspect, processing a requested computing action involving one of the entities based on the classification of the one of the entities as trusted or untrusted includes determining that an entity requesting a computing action is classified as untrusted, and requiring a second authentication factor from the entity before approving the computing action.

In an embodiment of the second aspect, the requested computing action includes an inter-party transaction, access to a shared computing resource, or access to a secure physical site.

In a third aspect of the present disclosure, a computer-implemented method is provided. The method includes collecting information respective of a plurality of transactions stored on a public blockchain, determining that a plurality of private user accounts for a domain are involved in respective ones of the plurality of transactions, determining one-to-one associations between the private user accounts according to the plurality of transactions, building a graph including a plurality of nodes, the nodes comprising the private user accounts, and a plurality of edges, the edges defined by the one-to-one associations, and applying a graph neural network to the graph to classify one or more of the private user accounts.

In an embodiment of the third aspect, classifying one or more of the private user accounts includes classifying one or more users, locations, or devices associated with the one or more of the private user accounts as trusted or non-trusted, evaluating a risk of a further transaction through the domain involving the one or more of the private user accounts, or predicting a next user action in a user interface respective of the domain.

In an embodiment of the third aspect, the nodes further include one or more of IP addresses, physical addresses, or device identifiers.

In an embodiment of the third aspect, determining one-to-one associations between the private user accounts includes determining a plurality of the transactions in which the private user accounts transacted with each other.

In an embodiment of the third aspect, determining one-to-one associations between the private user accounts includes determining a plurality of the transactions in which the private user accounts transacted with a common third party. In a further embodiment of the third aspect, the graph further includes information other than the transactions respective of each common third party.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
collecting, by a computing system, information respective of one or more transactions stored on a public blockchain;
determining, by the computing system, that a first private account hosted by the computing system is associated with a first transaction of the one or more transactions;
determining, by the computing system, that a second private account hosted by the computing system is associated with a second transaction of the one or more transactions;
associating, by the computing system, the first private account with the second private account based on a connection of the first transaction to the second transaction on the public blockchain; and
training, by the computing system, a machine learning model according to the association of the first private account with the second private account.

2. The computer-implemented method of claim 1, wherein determining that the first private account is associated with the first transaction comprises determining that the first transaction was conducted through a digital wallet hosted by the computing system and associated with the first private account.

3. The computer-implemented method of claim 2, wherein determining that the second private account is associated with the second transaction comprises determining that the second transaction was conducted through a digital wallet hosted by the computing system and associated with the second private account.

4. The computer-implemented method of claim 2, wherein determining that the first transaction was conducted through the digital wallet associated with the first private account comprises determining that a transactor address hash found on the public blockchain for a transaction matches a transactor address hash in the digital wallet associated with the first private account.

5. The computer-implemented method of claim 1, wherein the first transaction is the second transaction.

6. The computer-implemented method of claim 1, wherein:
the first transaction involves a first user of the first private account and a third user;
the second transaction involves a second user of the second private account and a fourth user;
a third transaction of the one or more transactions involves the third user and the fourth user; and
the third transaction comprises the connection of the first transaction and the second transaction.

7. The computer-implemented method of claim 1, wherein training the machine learning model according to the association of the first private account with the second private account comprises:
adding an edge between a node respective of the first private account and a node respective of the second private account to a graph and training a graph neural network according to the graph; or
adding the association to a training data set and training a machine learning classifier according to the data set.

8. The computer-implemented method according to claim 1, wherein training the machine learning model is further according to:
transactions on a private blockchain hosted by the computing system and involving the first private account or the second private account; and
inter-party transactions involving the first private account or the second private account and performed through the computing system.

9. A computing system comprising:
a processor; and
a computer-readable memory storing instructions that, when executed by the processor, cause the computing system to perform operations comprising:
accessing a machine learning model trained on one-to-one associations between private user accounts hosted by a service operating the computing system, the one-to-one associations established according to information respective of a plurality of transactions stored on a public blockchain, the plurality of transactions involving the user accounts;
applying the machine learning model to a plurality of entities to classify each of the plurality of entities as trusted or untrusted; and
processing a requested computing action involving one of the entities based on the classification of the one of the entities as trusted or untrusted.

10. The computing system of claim 9, wherein each of the plurality of entities comprises:
a user;
an IP address;
a physical address; or
a device identifier.

11. The computing system of claim 9, the one-to-one associations between the private user accounts are determined according to a plurality of the transactions in which the private user accounts transacted with each other.

12. The computing system of claim 9, wherein the one-to-one associations between the private user accounts are determined according to a plurality of the transactions in which the private user accounts transacted with a common third party.

13. The computing system of claim 9, wherein processing a requested computing action involving one of the entities based on the classification of the one of the entities as trusted or untrusted comprises:
determining that an entity requesting a computing action is classified as untrusted; and
requiring a second authentication factor from the entity before approving the computing action.

14. The computing system of claim 9, wherein the requested computing action comprises:
an inter-party transaction;
access to a shared computing resource; or
access to a secure physical site.

15. A computer-implemented method comprising:
collecting information respective of a plurality of transactions stored on a public blockchain;
determining that a plurality of private user accounts for a domain are involved in respective ones of the plurality of transactions;
determining one-to-one associations between the private user accounts according to the plurality of transactions;
building a graph comprising:
a plurality of nodes, the nodes comprising the private user accounts; and
a plurality of edges, the edges defined by the one-to-one associations; and
applying a graph neural network to the graph to classify one or more of the private user accounts.

16. The computer-implemented method of claim 15, wherein classifying one or more of the private user accounts comprises:
classifying one or more users, locations, or devices associated with the one or more of the private user accounts as trusted or non-trusted;
evaluating a risk of a further transaction through the domain involving the one or more of the private user accounts; or
predicting a next user action in a user interface respective of the domain.

17. The computer-implemented method of claim 15, wherein the nodes further comprise one or more of:
IP addresses;
physical addresses; or
device identifiers.

18. The computer-implemented method of claim 15, wherein determining one-to-one associations between the private user accounts comprises determining a plurality of the transactions in which the private user accounts transacted with each other.

19. The computer-implemented method of claim 15, wherein determining one-to-one associations between the private user accounts comprises determining a plurality of the transactions in which the private user accounts transacted with a common third party.

20. The computer-implemented method of claim 19, wherein the graph further comprises information other than the transactions respective of each common third party.
